(19) United States
(12) Patent Application Publication
(10) Pub. No.: US 2011/0174973 A1
(43) Pub. Date: Jul. 21, 2011

(54) High-Speed Molecular Analyzer System and Method

(76) Inventor: Norman Binz DeWalch, Houston, TX (US)

(21) Appl. No.: 12/989,073

(22) PCT Filed: Apr. 1, 2009
(86) PCT No.: PCT/US2009/002081

§ 371 Date: Apr. 5, 2011

Related U.S. Application Data
(63) Continuation of application No. 12/148,686, filed on Apr. 21, 2008.
Application No. 12/148,686 is a continuation-in-part of application No. 11/796,254, filed on Apr. 27, 2007, now abandoned.
Application No. 11/796,254 is a continuation of application No. 11/244,550, filed on Oct. 6, 2005, now abandoned.
Application No. 12/148,686 is a continuation-in-part of application No. 12/083,120, filed on Apr. 4, 2008.
(60) Provisional application No. 60/616,955, filed on Oct. 7, 2004.

(51) Int. Cl. G01N 23/00; G01J 1/58; H01J 40/14

(52) U.S. Cl. 250/310; 250/458.1; 250/200

(57) ABSTRACT

This invention relates to a device, in one example embodiment, for the determination of the sequence of nucleic acids and other polymeric or chain type molecules. The device analyzes a sample prepared by incorporating fluorescent dyes at the end of copies of varying lengths of the sample to be sequenced. The sample is then vaporized, charged and accelerated in an evacuated chamber. The individual molecules of the sample are accelerated to different velocities because of their different masses, which cause, in one embodiment, the molecules to be sorted by length as they travel along the evacuated chamber. Once sorted, the stream of molecules is illuminated causing the fluorescent dyes to emit light that is picked up by a detector. The output of the detector is then processed by a computer to yield of the sequence of the sample under analysis. Such an embodiment improves over the art by using photo-detection of the individual molecules instead of measuring the time of flight to a detector that measures collisions. Unlike mass spectrometry, the method of such an embodiment does not require the extreme sensitivity required to differentiate between very small mass differences in large molecules. Such an embodiment is therefore more robust than the art and well suited for high throughput sequencing of for example, various large nucleic acid molecules.

### CROSS-REFERENCE TO RELATED APPLICATIONS

This application is an International Application claiming priority to, and a continuation of, application Ser. No. 12/148,686 filed on Apr. 21, 2008, which is a continuation-in-part of application Ser. No. 11/796,254, filed Apr. 27, 2007, which is a continuation of application Ser. No. 11/244,550, filed Oct. 6, 2005, which claims the benefit of U.S. Provisional Application No. 60/616,955, filed Oct. 7, 2004. This application also is a continuation-in-part of application Ser. No. 12/083,120, which is a national stage of International Application No. PCT/US2006/033138, filed Aug. 23, 2006.

All written material, figures, content and other disclosure in each of the above-referenced applications is hereby incorporated by reference.

### BACKGROUND OF THE INVENTION

The present invention relates in general to an improved method, apparatus and system for analyzing molecules. More specifically, the invention relates to an improved method, apparatus and system for determining characteristics or properties of molecules isolated, for example, according to their mass.

Advances in the understanding of molecular biology and genetics and the future promise of biotechnology have created a need for improved tools to further the research that will revolutionize the world. New information provided by projects such as the Human Genome Project has created even more demand for faster, higher throughput methods for sequencing DNA. The tremendous efforts put into sequencing in the last decade have helped other researchers begin to understand fundamental cell function. These efforts have accelerated the pace of research and discoveries and have created a growing need for improved tools for analyzing a large variety of molecules in addition to DNA. The benefits to mankind in medicine, agriculture and for the environment, as well as the economic potential that these fields promise, are driving researchers to decipher the function of individual genes, molecules and the cells that contain them. By sequencing an organism's DNA and analyzing the molecules that make up its cells, researchers are able to develop an understanding of the systems and structure that make it function.

DNA sequencing has become an extremely important tool in molecular biology. DNA sequencing is the process of determining the nucleotide order of a given DNA fragment, called the DNA sequence. The amount of DNA sequence that organisms have varies from species to species but in all but the simplest organisms, the amount that must be determined is enormous. The Human Genome for example, consists of more than 3 billion nucleotide or “bases.” The real benefit from genomics will not be derived from just the sequence data; it will be from an undefstanding of the function of the genes and the proteins that they encode. In order to determine the function and significance of different genes it is particularly helpful to compare the DNA sequence of entirely different species as well as the DNA sequence of like species. The DNA sequence varies even for organisms of the same species and it is these differences that determine the different characteristics of different individuals. By obtaining the sequence data from many different organisms and individuals and correlating the different characteristics with differences in the genes, great insight can be gained about genetic function. However, this requires very large amounts of sequencing capacity. There have been many methods and machines developed to improve the speed and throughput of DNA sequencing, however it has taken thousands of people, hundreds of machines and several years just to sequence the human genome using the current technology. This is entirely too slow and too costly to be practical to meet the future needs of genomics.

A variety of different sequencing approaches have been developed; however, currently, almost all DNA sequencing is performed using a version of the chain termination method, developed by Frederick Sanger. This technique uses sequence-specific termination of an in vitro DNA polymerase catalyzed synthesis reaction using modified nucleotide substrates. The synthesized copies of the original DNA are then separated by electrophoresis and analyzed to determine the sequence of the original DNA.

The tremendous amount of DNA sequence that is now available in databases such as GenBank serves as a valuable resource and strong enticement to generate more sequence. Disciplines such as functional genomics and proteomics have arisen and use this data along with other research techniques to go beyond simple genes to begin to decipher the secrets of life. The growth of research in these fields has created a need for improved methods for analyzing other molecules such as proteins, carbohydrates, RNA, lipids and other bio-molecules in addition to the need for higher throughput, less expensive DNA sequencing technology.

Researchers make use of numerous analytical techniques to characterize and decipher the functions of molecules from living systems. Analytical techniques such as high performance liquid chromatography, mass spectrography, nuclear magnetic resonance, electron microscopy, x-ray fluorescence analysis, x-ray crystallography, spectrographic absorption and fluorescence analysis and many others each yield different bits of information very helpful to researchers. As the amount of research increases so has the number of samples to be analyzed. Many techniques in use today are still suited mainly for low throughput analysis.

Much of the sequence generated for the Human Genome Project was made possible in part by processes using electrophoretic analysis.

Electrophoretic sorting of copies of DNA to sequence a segment having 1000 bases even in some of the fastest equipment can take up to an hour or more. Typically after each run, the gel or medium for electrophoresis must be discarded or otherwise replaced or replenished which can add even more time to the process. Electrophoresis is slow, complex, and expensive and the equipment requires regular maintenance. This method is also subject to resolution problems due to the different mobility's imparted by different fluorescent dyes. Since each different dye affects the mobility differently, the movement of the tagged molecules through the gel is not purely dependant on the size of the original DNA and will be affected by which dye has been incorporated. The equipment must be reconditioned between runs which costs time and requires additional consumables. In order to sequence a single organism in a reasonable time frame it is necessary to perform a very high volume of reads in a short period. Since electrophoresis is slow, many electrophoresis machines must be purchased making the sequencing process very expensive (if not impractical for some projects) in both capital costs as well as maintenance costs. Electrophoresis is not suited to satisfy the needs for significantly higher throughput.

Another approach to sequencing DNA involves the use of mass spectrometers. This method uses the mass spectrometer to determine the sequence from mass measurements made on copies of the original sequence or on probe molecules. Mass spectrometry is also used to analyze atomic composition and in the identification and quantification of various molecular species in a sample. Mass spectrometry is growing in importance in molecular biology and is particularly important for use in protein analysis.

Mass spectrometry is also a tool of choice for analyzing bio-molecules. Many different approaches have been taken to improve detectors to help increase their utility. A common limitation that time of flight mass spectrometers have is the resolution that they are able to achieve when trying to simultaneously measure a broad range of molecules with large differences in mass. For example, when sequencing DNA using mass spectrometry, it is difficult to resolve the mass differences necessary to accurately identify the base for a given position when trying to sequence a molecule with more than about 50 bases.

To achieve good resolution in mass spectrometry, it is desirable that molecules of like size be tightly clumped with minimal overlap to provide discrete arrival times at the detector. Poor separation of different molecule species results in less resolution. Since the velocity of the molecule is proportional to its mass, small relative differences in mass result in small differences in velocity. One source of error is due to initial velocities that the molecules have before acceleration. These differences in velocity provide error that is difficult to distinguish from velocity differences caused by differences in mass. This means that measurements on large molecules such as oligonucleotides from a sequencing reaction that differ by only the slight difference in molecular mass between A, C, G or T become more difficult to resolve as the size of the entire molecule increases. This method has typically been limited to sequencing shorter lengths of nucleic acid due to the accuracy and resolution required for larger molecules. Additionally to improve resolution four separate reactions have been run for each of the A, C, G and T and then sequenced separately and re-assembled.

The detectors in time of flight mass spectrometers are typically less sensitive to larger molecules with low energies. If a mixture of nucleic acid sequence fragments is analyzed that contains a large number of fragments of different lengths, the small molecules will be detected, but the larger molecules must be accelerated at the end of the drift region in order to provide enough impact to provide a signal on the detector. This introduces additional complexity and source for error. This is another aspect that contributes to the difficulty that mass spectrometers have in providing good resolution when analyzing a group of molecules with a large range of mass values. Since many molecules of interest in molecular biology are large this is a limitation that would be helpful to overcome.

The detectors also have a limited life that depends on the number of molecules that strike them. This means that regular maintenance and replacement is usually required to keep them accurate, this increases cost and down time. This is problematic for a machine that is to be used for high-volume sequencing since by the very nature of the process, very large quantities of molecules must be processed.

Background noise is also a problem with many devices. Collisions of stray molecules with the detector cause noise that reduces sensitivity. For example, molecules that are either from the desorption matrix (in the case of MALDI-TOF) or become fragmented during acceleration and or drift can produce a signal that is not discernable from the actual molecules being measured.

Several examples of patents and publications which disclose various DNA sequencing methods and devices or attempts to solve some of the above problems are set forth as follows. Each of the following patents and publications is incorporated by reference herein.

U.S. Pat. No. 5,171,534 to Smith et al., entitled “Automated DNA sequencing technique,” sets forth a system for the electrophoretic analysis of DNA fragments produced in DNA sequencing operations comprising: a source of chromophore or fluorescent tagged DNA fragments; a zone for contacting an electrophoresis gel; means for introducing said tagged DNA fragments to said zone; and photometric means for monitoring said tagged DNA fragments as they move through said gel.

U.S. Pat. No. 6,847,035B2 to Sharma, entitled “Devices and methods for the detection of particles,” discloses devices and methods for determining the masses of particles by measuring the time between a first event such as a sample being ionized, (or a beam of electromagnetic radiation being scattered by a particle and electromagnetic radiation scattered by said particle being detected by a detection means,) and a second event in which a beam of electromagnetic radiation is scattered by a particle from said ionized sample and electromagnetic radiation from said beam scattered by said particle is detected by a detection means.

U.S. Pat. No. 6,995,841B2 to Scott et al., entitled “Pulsed-multiline excitation for color-blind fluorescence detection,” discloses a technology called Pulse-Multiline Excitation or PME. This technology provides a novel approach to fluorescence detection with application for high-throughput identification of informative SNPs, which could lead to more accurate diagnosis of inherited disease, better prognosis of risk susceptibilities, or identification of sporadic mutations. The PME technology has two main advantages that significantly increase fluorescence sensitivity: (1) optimal excitation of all fluorophores in the genomic assay and (2) “color-blind” detection, which collects considerably more light than standard wavelength resolved detection. Successful implementation of the PME technology will have broad application for routine usage in clinical diagnostics, forensics, and general sequencing methodologies and will have the capability, flexibility, and portability of targeted sequence variation assays for a large majority of the population.

U.S. Publication No. 2004/0057050 to Beck et al., entitled “Analysis systems detecting particle size and fluorescence,” sets forth particle analyzing systems with fluorescence detection, primarily in connection with particle sizing based on scattered light intensity or time-of-flight measurement. In one system, emission of fluorescence is used as a threshold for selecting particles for further analysis, e.g. mass spectrometry. In another embodiment, laser beams arranged sequentially along an aerosol path are selectively switched on and off, to increase the useful life of components, and diminish the potential for interference among several signals. Other embodiments advantageously employ color discrimination in aerodynamic particle sizing, single detectors positioned to sense both scattered and emitted fluorescent radiation, and laser beam amplitude or gain control to enhance the range of fluorescence detection.

U.S. Pat. No. 6,806,464 to Stowers et al., entitled “Method and device for detecting and identifying bio-aerosol particles the air,” discloses a method for detecting and identifying bioaerosol particles in the air, the bioaerosol particles in a particle stream are selected in an ATOFMS (aerosol time-of-flight mass spectrometer) by means of fluorescence techniques, and only the selected bioaerosol particles are ionized, for instance on the basis of MALDI (matrix-assisted laser desorption/ionization), after which the resulting ions are detected and the bioaerosol particles are identified. The selection of bioaerosol particles takes place by means of laser radiation, generated by a first laser device, of a wavelength which in specific substances in bioaerosol particles effects a fluorescence, after which by means of a fluorescence detector the bioaerosol particles are selected and a second laser device is triggered to emit light of a wavelength which effects the ionization of the bioaerosol particles selected only by the fluorescence detector.

U.S. Pat. No. 5,003,059 to Brennan, entitled “Determining DNA sequences by mass spectrometry,” relates to the methods, apparatus, reagents and mixtures of reagents for sequencing natural or recombinant DNA and other polynucleotides. In particular, this invention relates to a method for sequencing polynucleotides based on mass spectrometry to determine which of the four bases (adenine, guanine, cytosine or thymine) is a component of the terminal nucleotide. In particular, the present invention relates to identifying the individual nucleotides by the mass of stable nuclide markers contained within either the dideoxynucleotides, the DNA primer, or the deoxynucleotide added to the primer. This invention is particularly useful in identifying specific DNA sequences in very small quantities in biological products produced by fermentation or other genetic engineering techniques. The invention is therefore useful in evaluating safety and other health concerns related to the presence of DNA in products resulting from genetic engineering techniques.

U.S. Pat. No. 5,643,798 to Beavis, et al., entitled “Instrument and method for the sequencing of genome,” is directed to improved techniques for DNA sequencing, and particularly for sequencing of the entire human genome. Different base-specific reactions are utilized to use different sets of DNA fragments from a piece of DNA of unknown sequence. Each of the different sets of DNA fragments has a common origin and terminates at a particular base along the unknown sequence. The molecular weight of the DNA fragments in each of the different sets is detected by a matrix assisted laser absorption mass spectrometer to determine the sequence of the different bases in the DNA. The methods and apparatus of the present invention provide a relatively simple and low cost technique which may be automated to sequence thousands of gene bases per hour, and eliminates the tedious and time consuming gel electrophoresis separation technique conventionally used to determine the masses of DNA fragments.

U.S. Pat. No. 5,691,141 to Koster, entitled “DNA sequencing by mass spectrometry,” sets forth a new method to sequence DNA. The improvements over the existing DNA sequencing technologies are high speed, high throughput, no electrophoresis and gel reading artifacts due to the complete absence of an electrophoretic step, and no costly reagents involving various substitutions with stable isotopes. The invention utilizes the Sanger sequencing strategy and assembles the sequence information by analysis of the nested fragments obtained by base-specific chain termination via their different molecular masses using mass spectrometry, as for example, MALDI or ES mass spectrometry. A further increase in throughput can be obtained by introducing mass-modifications in the oligonucleotide primer, chain-terminating nucleoside triphosphates and/or in the chain-elongating nucleoside triphosphates, as well as using integrated tag sequences which allow multiplexing by hybridization of tag specific probes with mass differentiated molecular weights.

U.S. Pat. Nos. 6,541,765B1 and 6,281,493B1 to Vestal, both entitled “Time-of-flight mass spectrometry analysis of biomolecules,” are directed to a time-of-flight mass spectrometer for measuring the mass-to-charge ratio of a sample molecule. The spectrometer provides independent control of the electric field experienced by the sample before and during ion extraction. Methods of mass spectrometry utilizing the principles of this invention reduce matrix background, induce fast fragmentation, and control the transfer of energy prior to ion extraction. U.S. Pat. No. 5,998,215 to Prather et al., entitled “Portable analyzer for determining size and chemical composition of an aerosol,” discloses a portable analyzer for determining the size and chemical composition of particles suspended in an aerosol. The aerosol is accelerated through a nozzle and skimmers, to produce a well-defined beam of particles, the speed of which is inversely related to the particle size. A dual-beam laser system positioned along the beam path detects light scattered from each particle, to determine the particle's velocity and thus its aerodynamic size. The laser system also triggers a laser to produce a beam that irradiates the particle, to desorb it into its constituent molecules. The particle is desorbed in a source region of a bipolar, time-of-flight mass spectrometer, which provides a mass-to-charge spectrum of the desorbed molecule, thereby chemically characterizing the material of the particle. Several structural features provide sufficient ruggedness to allow the analyzer to be easily used in the field with minimum calibration and maintenance.

U.S. Pat. No. 5,681,752 to Prather et al., entitled “Method and apparatus for determining the size and chemical composition of aerosol particles,” sets forth an improved mass spectrometer apparatus, and related method, that characterizes aerosol particles, in real time, according not only to their chemical composition, but also to their size. This added information can be of critical importance when evaluating risks associated with aerosol particles of particular chemical composition. The apparatus achieves this beneficial result in a reliable fashion by first detecting the presence and size of individual aerosol particles moving along a predetermined particle path and by then directing a pulse of high-intensity light at the particle, to desorb and ionize the particle, for analysis of its chemical composition.

U.S. Pat. No. 5,654,545 to Holle et al., entitled “Mass resolution in time-of-flight mass spectrometers with reflectors,” discloses a method for the high resolution analysis of analyte ions in a time-of-flight mass spectrometer. The method consists of the generation of an intermediate time-focus plane for ions of a certain mass at a location between an ion source and an ion reflector, and then using the ion reflector to temporally focus the ions of equal mass and differing velocities which pass this plane at the same time onto a detector. For time-of-flight mass spectrometers with an ion selector, the ion selector is particularly favorable location for this intermediate plane with time focus; and with a collision cell for the collision fragmentation of the ions, the collision cell is a particularly favorable location.

Various articles and publications include the following:

Mark T. Roskey, Peter Juhasz, Igor P. Smirnov, Edward J. Takach, Stephen A. Martin and Lawrence A. Haff (1996). DNA sequencing by delayed extraction-matrix-assisted laser desorption/ionization time of flight mass spectrometry. Proc. Natl. Acad. Sci. USA. Vol. 93, pp. 4724-4729, May 1996. Biochemistry. PerSeptive Biosystems, 500 Old Connecticut Path, Framingham, Mass. 01701. Communicated by Klaus Biemann, Massachusetts Institute of Technology, Cambridge, Mass., Jan. 11, 1996 (received for review Nov. 10, 1995).
http://www.pubmedcentral.nih.gov/picrender.fcgi?artid=39346&blobtype=pdf

Finn Kirpekar*, Eckhard Nordhoff, Leif K. Larsen, Karsten Kristiansen, Peter Roepstorff, Franz Hillenkamp (1998). DNA sequence analysis by MALDI mass spectrometry. Department of Molecular Biology, Odense University, Campusvej 55, DK-5230 Odense M, Denmark and ¹Institute for Medical Physics and Biophysics, University of Münster, Robert-Koch-Strasse 31, D-48149 Münster, Germany. Received Mar. 10, 1998; Revised and Accepted Apr. 16, 1998.
http://nar.oxfordjournals.org/cgi/content/abstract/26/11/2554

N. I. Taranenko, S. L. Allman, V. V. Golovlev, N. V. Taranenkol, N. R. Isola and C. H. Chen* (1998). Sequencing DNA using mass spectrometry for ladder detection. 2488-2490 Nucleic Acids Research, 1998, Vol. 26, No. 10. Life Science Division, Oak Ridge National Laboratory, Oak Ridge, Tenn. 37831-6378, USA and 1 Yale University Medical Center, New Haven, Conn., USA. Received Dec. 3, 1997; Revised and Accepted Mar. 23, 1998.
http://www.pubmedcentral.nih.gov/picrender.fcgi?artid=147544&blobtype=pdf

Eckhard Nordhoff,^{a} Christine Luebbert, Gabriela Thiele, Volker Heiser, and Hans Lehrach (2000). Rapid determination of short DNA sequences by the use of MALDI-MS. Nucleic Acids Res. 2000 Oct. 15 ; 28(20): e86. Max Planck Institute for Molecular Genetics, Ihnestrasse 73, 14195 Berlin, Germany. To whom correspondence should be addressed. Tel: +49 30 8413 1542; Fax: +49 30 8413 1139; Email: nordhoff@molgen.mpg.de. Received Aug. 21, 2000; Accepted Aug. 22, 2000.
http://www.pubmedcentral.nih.gov/articlerender.fcgi?artid=110802

Annette Kaetzke and Klaus Eschrich (2002). Simultaneous determination of different DNA sequences by mass spectrometric evaluation of Sanger sequencing reactions. Nucleic Acids Research, 2002, Vol. 30, No. 21 e117. Institute of Biochemistry, Medical Faculty, University of Leipzig, Liebigstrasse 16, D-04103 Leipzig, Germany. *To whom correspondence should be addressed. Tel: +49 341 9722105; Fax: +49 341 9739371; Email: eschrich@uni-leipzig.de
http://nar.oxfordjournals.org/cgi/content/abstract/30/21/e117

While the mass spectrometer can provide fast analysis of molecules, numerous practical limitations prevent it from being the high throughput tool that is needed. A sequencing method that can provide the speed of mass spectrometry and the convenience of one sequencing reaction for all bases as well as good read lengths is clearly needed. Therefore, there is a need to determine the sequence of nucleic acids and analyze other molecules and collections of molecules in a much faster and more economical way. Additionally, a high throughput instrument for analyzing molecules such as bio-molecules is needed and would be particularly helpful in analyzing biological systems. Whatever the precise merits features and advantages of the above cited references, none of them achieves or fulfills the purpose of the invention as set forth herein.

Those of skill in the art will appreciate the present invention which addresses the above needs and other significant needs the solution to which are discussed hereinafter.

### SUMMARY OF THE INVENTION

An example embodiment of the invention provides a method and apparatus for analyzing at least one molecule. An aspect of such an embodiment includes at least: isolating at least one molecule wherein the isolating depends substantially on the mass of the at least one molecule; subsequently interacting the at least one molecule with a radiant signal inducer; and detecting a signal resulting from the interacting of the at least one molecule and the radiant signal inducer.

Analyzing includes, for example, but is not limited to determining: the atomic composition of one or more molecules; the mass of one or more molecules; at least one subunit of at least one molecule comprising two or more subunits; and the concentration of one or more molecules in a sample. Analyzing also may include but is not limited to nucleic acid sequencing, DNA sequencing, single nucleotide polymorphism (SNP) analysis, and protein sequencing.

The at least one molecule includes but is not limited to organic molecules as well as inorganic molecules. In certain embodiments, organic molecules include but are not limited to bio-molecules. Inorganic molecules include but are not limited to inorganic monomers and inorganic polymers. Bio-molecules include but are not limited to small molecules, organic monomers, organic polymers and macromolecules. Small molecules include but are not limited to lipids, phospholipids, glycolipids, sterols, vitamins, hormones, neurotransmitters, carbohydrates, sugars and disaccharides. Monomers include but are not limited to amino acids, nucleotides, phosphates and monosaccharides. Organic polymers include but are not limited to nucleic acids, peptides, oligosaccharides and polysaccharides. Macromolecules include but are not limited to prions. Nucleic acids include but are not limited to ,DNA, RNA and oligonucleotides. Peptides include but are not limited to oligopeptides, polypeptides, proteins and antibodies.

Other embodiments of the invention are configured to analyze molecules such as: at least one fragment molecule wherein the fragment has been prepared by using the at least one molecule as a template. The at least one fragment molecule may also have a known subunit in a known position on the fragment. Additionally, molecules to be analyzed may comprise a tag that is capable of producing a signal when interacted with a signal inducer such as but not limited to a fluorophore. One embodiment of the invention analyzes a molecule comprising a subunit comprising a fluorescent tag in a known position wherein the tag is characteristic of the subunit comprises it.

The isolating depending substantially on the mass of the at least one molecule may have numerous embodiments including but not limited to the following: one embodiment comprises ionizing and accelerating the at least one molecule to be analyzed and allowing it to drift a sufficient distance to allow isolation dependent upon its mass; one embodiment of the invention comprises a time of flight (TOF) mass analyzer; one embodiment of the invention comprises a quadrupole mass analyzer; another embodiment comprises a magnetic-sector mass analyzer; another embodiment comprises a quadrupole ion trap mass analyzer and a further embodiment comprises a Fourier transform ion cyclotron resonance mass analyzer.

In one embodiment of the invention the radiant signal inducer comprises electromagnetic radiation. Another embodiment of the invention comprises particle radiation. Examples of electromagnetic radiation suitable for various embodiments of the invention include: radio frequency radiation, microwave radiation, infrared radiation, visible light, ultraviolet light, x-ray radiation and gamma ray radiation. Examples of particle radiation suitable for various embodiments of the invention include: protons neutrons, electrons, positrons, alpha particles and molecules. These types of radiation can be used separately or in combination

One example embodiment comprises a laser as a source of a radiant signal inducer. The laser may independently comprise a diode laser, a semiconductor laser, a gas laser, such as an argon ion, krypton, or helium-neon laser, a diode laser, a solid-state laser such as a Neodymium laser which will include an ion-gain medium, such as YAG and yttrium vanadate (YVO₄), or a diode pumped solid state laser. Other devices, which produce light at one or more discrete excitation wavelengths, may also be used as a source of radiant signal inducer such as a flash lamp. One example embodiment the source of radiant signal inducer comprises a xenon flash lamp. Another example embodiment the source of a radiant signal inducer comprises an x-ray tube.

In one example embodiment the source of a radiant signal inducer comprises a source of particles. Examples of sources of particles include an electron gun and radioisotopes.

An aspect of the present invention includes interacting at least one molecule with a radiant signal inducer after being isolated depending substantially upon the mass of the at least one molecule. One example embodiment comprises a time of flight mass analyzer and a laser beam directed to intersect the flight path of the at least one molecule through the TOF mass analyzer such that when the at least one molecule passes through the TOF mass analyzer it interacts with the laser beam. Another example embodiment comprises a quadrupole ion cyclotron mass analyzer and an x-ray tube disposed generally at the exit of the quadrupole ion cyclotron mass analyzer such that when the at least one molecule exits the mass analyzer it passes through the x-ray radiation emitted from the x-ray tube and thereby interacts with the x-ray radiation and produces a signal characteristic of a property of the at least one molecule.

In one example embodiment the radiant signal inducer radiates in substantially parallel paths from at least one source. In another example embodiment the radiant signal inducer radiates in substantially non-parallel paths from at least one source.

The signal inducer may be emitted continuously from at least one source or be emitted in one or more pulses from at least one source. The pulsed emission may comprise control circuitry to control the emission of the one or more pulses.

The signal produced as a result of the interaction of the radiant signal inducer may comprise any form of electromagnetic radiation or particle radiation or combinations of the same. The signal produced can be the result of luminescence such as fluorescence resulting from the interaction. Interaction of the radiant signal inducer and the at least one molecule can be detected by: detecting absorption of the radiant signal inducer by the at least one molecule or by detecting emission of a particle or electromagnetic radiation or by detecting scattering of the radiant signal inducer or by detecting reflection of the radiant signal inducer or by detecting a combination of two or more of these phenomena.

The detector may comprise a charged couple device, a photomultiplier tube, a silicon avalanche photodiode, a silicon PIN detector, a wavelength dispersive spectrometer or an energy dispersive spectrometer. It may also comprise filters to selectively pass or block electromagnetic radiation or particles depending upon the wavelength of the electromagnetic radiation or the energy of the signal to be detected or the type of particle.

The present invention may further comprise data processing apparatus for processing of the signals detected.

In one example embodiment, a method for analyzing at least one molecule is provided. The method includes at least: providing at least one molecule; isolating the at least one molecule; causing the at least one molecule to emit a signal; and detecting the signal.

Another example embodiment of an apparatus includes a novel device for the analysis of nucleic acid fragments including at least: a source of chromophore or fluorophore tagged nucleic acid fragments, the chromophore of fluorophore being distinguishable by the spectral characteristics; means for vaporization and acceleration of said nucleic acid fragments; means for introducing the tagged nucleic acid fragments to the vaporization and acceleration means; a drift region; said vaporization and acceleration means being located at one end of said drift region and directed so as to propel said nucleic acid fragments through said drift region; detecting means located at the end of said drift region generally opposite said accelerating and vaporization means; said detecting means comprises means for inducing emission from the tagged nucleic acid fragments and means for detecting emissions from said tagged nucleic acid fragments and distinguishing said tagged nucleic acid fragments.

In another example embodiment of the apparatus, the apparatus includes at least vaporization and ionization means comprising electro-spray ionization.

In another example embodiment of the apparatus, the apparatus includes at least a vaporization and ionization means comprising matrix assisted laser desorption ionization.

In another example embodiment of the apparatus, the apparatus includes at least a source of illumination comprising a laser.

In another example embodiment of the apparatus, the apparatus includes at least means for detecting emissions comprising a prism and one or more photo detectors located at positions corresponding to unique spectral positions.

Another example embodiment of a method includes a method of determining the sequence of nucleic acids comprising the following steps: introduction of chromophore of fluorophore tagged nucleic acid fragments, said chromophore of fluorophore being distinguishable by its spectral characteristics; vaporization of said nucleic acid fragments; acceleration of said nucleic acid fragments; stimulation of said nucleic acid fragments by external means so as to induce emissions from said tag; and detection of said emissions.

Another example embodiment of an apparatus includes a device for the determination of the sequence of a nucleic acid sample comprising: a generally tubular chamber; said chamber being evacuated sufficiently to prevent degradation of said sample during analysis; means for electrospray ionization of said sample; an accelerating grid adjacent the injector; an un-obstructed section of sufficient length to allow separation of said sample after acceleration by said accelerating grid; a laser directed to intersect the path of flight of said sample, positioned at the end of said un-obstructed section, opposite said accelerating grid; a photo-detector located sufficiently close to said intersection of said illumination source and said path of flight of said sample.

Another example embodiment comprises a photo-detector located sufficiently close to said intersection of said illumination source and said path of flight of said sample.

Another example embodiment comprises an un-obstructed section of sufficient length to allow separation of said sample after acceleration by said accelerating grid.

Another example embodiment comprises a source of illumination directed to intersect said path of flight of said nucleic acid fragments, positioned at the end of said tubular chamber, opposite said vaporization and acceleration means.

Another example embodiment comprises a chamber being evacuated sufficiently to prevent degradation of said nucleic acid fragments during analysis.

Another example embodiment comprises at one end of said chamber, means for vaporization and acceleration of said nucleic acid fragments along a path of flight generally in the direction of the axis of said tubular chamber.

Another example embodiment provides a method for analyzing at least one molecule Comprising: Providing item to be analyzed; isolating the item to be analyzed; causing the item to be analyzed to emit a signal.

Another example embodiment provides a method for analyzing at least one molecule comprising: providing at least one molecule; isolating the at least one molecule; causing the at least one molecule to emit a signal; and detecting the signal.

Another example embodiment provides a method for analyzing at least one molecule comprising: providing at least one molecule; causing the at least one molecule to have a non-neutral charge; separating the at least one molecule based on its mass to charge ratio; causing the at least one molecule to emit a detectable signal; detecting said signal; recording said signal.

Another example embodiment provides a method for determining the identity of at least one base of at least one polynucleotide comprising: providing a population of fluorescently labeled fractions; each fraction having a unique fluorescent label characteristic of the base at its end position; accelerating the population of fractions in a manner so as to impart generally the same amount of energy to each molecule; allowing the population of fractions to travel a distance sufficient to separate like fractions into differentiable groups; causing at least one of the fluorescent labels on at least one of the fractions to fluoresce; and detecting the signal emitted from the label.

Another example embodiment provides a method for analyzing at least one molecule comprising: providing at least one molecule; accelerating the at least one molecule; allowing the at least one molecule to travel a distance; causing the at least one molecule to emit a detectable signal; detecting said signal; recording said signal.

Another example embodiment of the method includes at least sequencing a group of molecules, wherein each molecule comprises multiple sub-units of differing sub-unit types, wherein each of the molecules includes at least one tag specific to the sub-unit type, the method comprising: accelerating said molecules, separating said molecules dependant upon at least said accelerating, and radiant detecting of each of the at least one tags by the tag type of each of the at least one tags.

In another example embodiment of the method, the method includes at least radiant detecting comprises electromagnetic radiant detecting.

In another example embodiment of the method, the method includes at least radiant detecting comprising phosphorescent radiant detecting.

In another example embodiment of the method, the method includes at least radiant detecting comprising fluorescent radiant detecting.

In another example embodiment of the method, the method includes at least radiant detecting comprising thermal radiant detecting.

In another example embodiment of the method, the method includes at least radiant detecting comprising radioactive radiant detecting.

In another example embodiment of the method, the method includes at least radiant detecting comprising particle radiant detecting.

In another example embodiment of the method, the method includes at least radiant detecting comprising chemical-reactive radiant detecting.

In another example embodiment of the method, a further method includes at least radiant detecting comprising detecting the radiation of the tag with a detector.

In another example embodiment of the further method, the method includes at least radiant detecting comprising electromagnetic radiant detecting.

In another example embodiment of the further method, the method includes at least radiant detecting comprising phosphorescent radiant detecting.

In another example embodiment of the further method, the method includes at least radiant detecting comprising fluorescent radiant detecting.

In another example embodiment of the further method, the method includes at least radiant detecting comprising thermal radiant detecting.

In another example embodiment of the further method, the method includes at least radiant detecting comprising radioactive radiant detecting.

In another example embodiment of the further method, the method includes at least radiant detecting comprising particle radiant detecting.

In another example embodiment of the further method, the method includes at least radiant detecting comprising chemical-reactive radiant detecting.

In another example embodiment of the method, a further method includes at least radiant detecting comprising detecting the radiation of a detection substance upon contact with the tag.

In another example embodiment of the further method, the method includes at least radiant detecting comprising electromagnetic radiant detecting.

In another example embodiment of the further method, the method includes at least radiant detecting comprising phosphorescent radiant detecting.

In another example embodiment of the further method, the method includes at least radiant detecting comprising fluorescent radiant detecting.

In another example embodiment of the further method, the method includes at least radiant detecting comprising thermal radiant detecting.

In another example embodiment of the further method, the method includes at least radiant detecting comprising radioactive radiant detecting.

In another example embodiment of the further method, the method includes at least radiant detecting comprising particle radiant detecting.

In another example embodiment of the further method, the method includes at least radiant detecting comprising chemical-reactive radiant detecting.

In molecular biology and materials science there is a growing need for the identification and characterization molecules. The device of the current invention would allow the determination of various characteristics such as mass, absorbance and fluorescence signatures and possibly molecular structure.

An embodiment of the invention is an apparatus for determining the sequence of DNA molecules, however the invention can be applied to many analytical purposes in characterizing molecules.

A method for analyzing at least one molecule comprising: accelerating the at least one molecule; allowing the molecule to travel a distance; remotely detecting a signal from the molecule after traveling said distance; recording said signal from said detecting.

In one example embodiment an apparatus provided, for determining the sequence of DNA, is similar to a time of flight mass spectrometer and has four basic components:
1. A molecule accelerator that ionizes and accelerates the molecule of interest. This can be an apparatus such as an electro-spray device or a matrix assisted laser desorption ionization device.
2. A flight tube that is connected to the accelerator and provides a path for the molecules to travel after they are accelerated. This flight tube would be held at a vacuum to minimize collisions during the flight of the molecule being analyzed.
3. A detection device that comprises: a laser directed generally normal to the flight path of the molecules and located at the end of the flight tube opposite from the accelerator; 4 photon detectors such as photo-multiplier tubes located in the same plane as the laser and oriented generally normal to the laser beam; a refractor for dispersing light into its component colors and directing the light at one of each of the 4 photon detectors.
4. A data recording device that records the signals from each of the detectors.

The operation of the apparatus is as follows: The DNA to be analyzed is prepared in a manner typical for analysis in a 4 color capillary sequencing device. This process produces a population of molecules that range in length from a few molecules to the original length of the DNA molecule to be analyzed. During the sequencing reaction a fluorescent dye is incorporated at the end of each of these molecules. The tags fluoresce when excited by a laser and emit one of 4 colors representing the base for that end position.

The DNA prepared as described above is introduced into the accelerator component of the apparatus of the current embodiment of the invention. A group of these molecules are ionized and accelerated by the accelerator and directed to travel down the flight tube.

As a result of traveling the distance of the flight tube the molecules are fractionated by length. Since all molecules are imparted the same amount of energy by the accelerator, each molecule of a given length travels at a different velocity. The smallest molecules travel the fastest and the next smallest next fastest, etc. until the largest molecules which travel the slowest. This velocity difference causes the molecules to pass the detector at different times and thus accomplishes the fractionation.

As each molecule group passes the detector they are illuminated by the laser. This illumination causes the fluorescent dyes to emit light which passes through the refractor and is directed to the appropriate photo detector.

The data recording device records the detector signal strength and the time detected.

After all of the molecules have passed the detector, the data recorded then can be analyzed and the exact sequence of the original DNA molecule determined by correlating the wavelength detected and the order in which it was detected. This data can be provided in the form of a human-readable and/or machine-readable report. In one example embodiment, a method is provided for generating a report based on the process including the isolation of a desired target, interaction with the target, detection based on the interaction, determination of data, properties, or other information based on the process and generation of a report based on the determination.

An example embodiment is shown in block diagram form in FIG. 1. FIG. 1 illustrates an apparatus comprising a sample accelerator 1, a drift tube 2 and a detector 3. The chamber in the drift tube (see 8) and the area inside the detector are maintained at high vacuum by vacuum pumps connected at ports 5 and 6. The sample accelerator vaporizes, ionizes and accelerates the sample molecules down the drift tube along the path 7 and through the detector chamber 15. While passing through the detector 3, the sample ions are illuminated by the laser beam 11 causing the fluorescent dye terminator molecules incorporated into the sample molecules to emit light. The photo detector 9 then detects this light. The particular dye terminator incorporated at the end of the molecule corresponds to the original nucleotide of the molecule being sequenced. Once past the detector, the sample molecules are then cleared from the chamber mainly by the vacuum pump connected to port 6.

Referring to the block diagram in FIG. 1, the sample molecules to be analyzed are vaporized and ionized by ionizing means 1. The ionizing means 1 can be any device that provides a source of ionized molecules of sample without causing excessive degradation of the sample molecules. Devices that are commonly used to do this use techniques such as Matrix Assisted Laser Desorption Ionization (MALDI) and Electrospray Ionization (ES). These techniques are commonly used to provide sample ion sources for Time of Flight Mass Spectrometers and are well known. Each device has particular advantages and disadvantages but serves as means to convert the sample to be analyzed to a gaseous ionized collection of molecules. The ionizing means accelerates the sample molecules to a velocity that is proportional to their mass to charge ratio. Thus, the smaller molecules will have higher velocities than the larger molecules. The molecules exit the ionizing meansl through exit port 14 with a velocity directed down the drift tube 2. The dashed line 7 represents the flight path of the molecules, which travel down the drift tube past the detection point 13. As the molecules travel the distance down the drift tube, the smaller (faster moving) molecules travel the distance faster than the larger molecules. This results in a separation of the sample such that the molecules pass the detection point in order of increasing size with smallest arriving first and largest arriving last. The chamber areas in the drift tube (see 7) and detector 15 are maintained at a high vacuum. The vacuum should be sufficient so as to prevent collisions between the sample and stray molecules causing excessive fragmentation and disruption of the sorting process.

The sample to be sequenced is injected at 1. Very quickly after injection the sample breaks into very small droplets that evaporate and leave the individual molecules in a charged state.

After the sample is fully vaporized the accelerating grid 2 is turned on accelerating the molecules from the sample through the grid. After passing through the grid they travel down a drift section that is an un-obstructed section of the chamber. This section is of sufficient length to allow separation of said sample after acceleration by the accelerating grid. The molecules are accelerated to a velocity that is proportional to their mass to charge ratio. Therefore molecules of like mass (size) will be accelerated to very near the same velocity. As the molecules travel down the drift section, the fastest (smallest) molecules are the first to reach the detector section. The next smallest molecules arrive next and so on until all of the molecules from the sample have passed the detector section.

An object of the invention is to make large-scale sequencing of nucleic acids faster, simpler and lower in cost. Several other objects and advantages of the present invention are to provide a method and an apparatus to sequence polymeric or chain type molecules such as nucleic acids:
a) in larger volumes in a shorter amount of time;
b) having larger molecular size with greater accuracy;
c) as a continuous process without requiring reconditioning between each run;
d) with lower maintenance requirements;
e) with a lower sequencing cost per base.

An example embodiment of the invention is a method and apparatus for determining the sequence polymeric or chain type molecules such as nucleic acids. This example embodiment comprises a source of chromophore or fluorophore tagged molecule fragments each being distinguishable by its spectral characteristics; a means for vaporization and acceleration of the molecule fragments; means for introducing the tagged molecule fragments to the vaporization and acceleration means; a drift region having the vaporization and acceleration means located at one end of the drift region and directed so that it propels the molecule fragments through the drift region; detecting means located at the end of the drift region generally opposite the accelerating and vaporization means. The detecting means comprises means for inducing emission from the tagged molecule fragments; means for detecting emissions from the tagged molecule fragments and distinguishing the tagged molecule fragments.

Sequencing of polymeric or chain type molecules such as DNA is accomplished by producing duplicate copies of varying lengths of the original sequence that are terminated with a base specific chromophore or fluorophore. Four different chromophores or fluorophores are used (one for each possible nucleotide) and each terminating molecule emits a unique emission spectrum when excited. The prepared DNA or nucleic acid is then loaded into the present invention for analysis. The nucleic acid fragments are then vaporized, ionized and accelerated by an electric field and directed down the drift region. The nucleic acid fragments are all subjected to approximately the same force in the accelerating field; however, since each fragment of a different length has a different mass, each is accelerated to a different final velocity. As the nucleic acid fragments travel through the drift region, their differences in velocity cause them to be sorted from smallest to largest, the smallest arriving first and largest last. The detector illuminates the molecules as they pass and a sensor receives the resulting emission. The detector is designed to sense characteristic emission spectrum of each tagged nucleotide allowing determination of the individual bases. The output from each sensor is then an accurate, ordered sequential representation of the bases in the original molecule under analysis.

This design achieves very high throughputs in contrast with electrophoresis. Electrophoresis can typically take at least an hour for the sample to pass completely by the detector compared to fractions of a second for the present invention. The present invention requires virtually no reconditioning. All that is necessary to prepare the machine to sequence another sample is for the vacuum pump to clear the molecules from the previous sample out of the vacuum chamber, which happens very quickly.

The present invention has advantages over mass spectrometry since the detection method depends on detection of the wavelength of the emission from the florescent tags not precise measurements of time between discrete collisions.

The apparatus required is relatively simple with very few parts to fail; therefore, the maintenance requirements are lower than the prior art. The machine can be made to operate automatically and there is next to no reconditioning required between runs so the labor cost per sample is lower than the prior art.

The content and disclosure of each of the following applications/publications to the extent permitted are specifically hereby incorporated by reference: U.S. patent application Ser. No. 11/796,254, filed Apr. 27, 2007; U.S. patent application Ser. No. 11/244,550, filed Oct. 6, 2005; U.S. Provisional Application No. 60/616,955, filed Oct. 7, 2004. U.S. application Ser. No. 12/083,120, filed on Apr. 4, 2008 (which is a national stage of International Application No. PCT/US2006/033138, filed Aug. 23, 2006); International Application No. PCT/US2006/033138, filed Aug. 23, 2006.

These and other objects, features, and advantages of example embodiments of the present invention will become apparent from the drawings, the descriptions given herein, and the appended claims. Further objects are also indicated herein in various example embodiments of the invention. However, it will be understood that the above-listed objectives and/or advantages of example embodiments are intended only as an aid in quickly understanding aspects of the example embodiments, are not intended to limit the embodiments of the invention in any way, and therefore do not form a comprehensive or restrictive list of objectives, and/or features, and/or advantages.

There has thus been outlined, rather broadly, features of example embodiments of the invention in order that the detailed description thereof may be better understood, and in order that the present contribution to the art may be better appreciated. There are additional features of example embodiments of invention that will be described hereinafter.

In this respect, before explaining at least one example embodiment of the invention in detail, it is to be understood that the example embodiments are not limited in its application to the details of construction and to the arrangements of the components set forth in the following description or illustrated in the drawings. Various example embodiments are capable of other further embodiments and of being practiced and carried out in various ways. Also, it is to be understood that the phraseology and terminology employed herein are for the purpose of the description and should not be regarded as limiting.

To the accomplishment of the above and related objects, example embodiments of the invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

The drawings as noted below form part of the present specification and are included to further demonstrate certain aspects of example embodiments of the invention. Various other objects, features and attendant advantages of the embodiments of the invention will become fully appreciated as the same becomes better understood when considered in conjunction with the accompanying drawings, in which like reference characters designate the same or similar parts throughout the several views, and wherein:

FIG. 1 shows a schematic diagram of a example nucleotide-sequencing device in accordance with an example embodiment of the invention.

FIG. 2 shows a symbolic representation of a hypothetical nucleic acid sequence paired with a complimentary nucleic acid copy terminated with a base specific label molecule in accordance with an example embodiment of the invention.

FIG. 3 shows a symbolic representation of a vaporized group of hypothetical nucleic acid copies of different lengths; illustrating a random special orientation of the different length molecules in accordance with an example embodiment of the invention.

FIG. 4 shows a symbolic representation of the same molecules in FIG. 3 shortly after being accelerated; illustrating separation of the sizes in accordance with an example embodiment of the invention.

FIG. 5 shows a symbolic representation of the same molecules in FIG. 3 after being accelerated and traveling for sufficient time to effect significant separation by size in accordance with an example embodiment of the invention.

FIG. 6 shows a schematic representation of the detector optics of an example embodiment.

FIG. 7 shows a symbolic representation of a group of molecules under analysis and the corresponding outputs from the detectors sensing them.

FIG. 8 shows a cross section of an example detector having a single photo detector.

FIG. 9 shows a schematic diagram of an example nucleic acid sequencing device in accordance with an example embodiment of the invention.

FIG. 10 shows a schematic diagram of an example molecular analysis device in accordance with an example embodiment of the invention.

FIG. 11 shows a schematic diagram of an example a wavelength dependent photon detector in accordance with an example embodiment of the invention.

FIG. 12 shows a schematic diagram of an example molecular detector in accordance with an example embodiment of the invention.

FIG. 13 shows a schematic diagram of an enlarged view of the region where a molecule is in a position to interact with the signal inducer pulses in accordance with an example embodiment of the invention.

FIG. 14 shows a schematic diagram of an enlarged view of the region where a molecule is in a position to interact with the signal inducer pulses in accordance with an example embodiment of the invention.

FIG. 15 shows a schematic diagram of an enlarged view of the region where a molecule is in a position to interact with the signal inducer pulses in accordance with an example embodiment of the invention.

FIG. 16 shows a schematic diagram of an enlarged view of the region where a molecule is in a position to interact with the signal inducer pulses in accordance with an example embodiment of the invention.

FIG. 17 shows a schematic diagram of an enlarged view of the region where a molecule is in a position to interact with the signal inducer pulses in accordance with an example embodiment of the invention.

FIG. 18 shows a schematic diagram of an enlarged view of the region where a molecule is in a position to interact with the signal inducer pulses in accordance with an example embodiment of the invention.

FIG. 19 shows a schematic diagram of the molecule in a position to interact with the radiant signal inducer and illustrates how the pulse time can be calculated in accordance with an example embodiment of the invention.

FIG. 20 shows a schematic diagram of an example molecular analysis device in accordance with the present invention.

FIG. 21 shows a schematic diagram of an example molecular analysis device in accordance with an example embodiment of the invention.

FIG. 22 shows a schematic diagram of an example molecular analysis device in accordance with an example embodiment of the invention.

FIG. 23 shows a schematic diagram of an example molecular analysis device in accordance with an example embodiment of the invention.

FIG. 24 shows a schematic diagram of an example molecular sequencing device in accordance with an example embodiment of the invention.

FIG. 25 shows a schematic diagram of a molecule with two or more subunits in accordance with an example embodiment of the invention.

FIG. 26 shows a schematic diagram of a molecule fragments in accordance with an example embodiment of the invention.

FIG. 27 shows a schematic diagram of a molecule fragments in accordance with an example embodiment of the invention.

FIG. 28 shows a schematic diagram of a molecule fragments in accordance with an example embodiment of the invention.

FIG. 29 shows a schematic diagram of time measurements recorded for fragment groups in accordance with an example embodiment of the invention.

FIG. 30 shows a schematic diagram of an example molecular analysis device in accordance with an example embodiment of the invention.

While various example embodiments of the invention will be described herein, it will be understood that it is not intended to limit the invention to those embodiments. On the contrary, it is intended to cover all alternatives, modifications, and equivalents included within the spirit of the invention and as defined in the appended claims.

### DETAILED DESCRIPTION OF THE INVENTION

In one example embodiment of the invention, a device and method is provided for the high-speed analysis of molecules for determining characteristics, for example, such as: atomic composition; mass; sequence of subunits and/or the concentration of one or more molecules in a sample. Such an embodiment may also be used, for example, for one or more of the following or a combination thereof: nucleic acid sequencing; DNA sequencing; single nucleotide polymorphism (SNP) analysis; and protein sequencing.

In one example embodiment of the invention an apparatus is provided for determining the sequence of bases or nucleotides in a nucleic acid such as DNA or RNA.

The basic steps involved in the process include:
a) Making copies ranging in length from 1 nucleotide to the same length as the molecule under analysis;
b) Incorporating a base specific molecule at the end of the copy that corresponds to the base of the original molecule at that position and has a dye molecule that emits a uniquely identifiable spectrum when induced by external means;
c) Vaporizing the molecules;
d) Accelerating the molecules in a way so as to impart substantially the same energy to each molecule;
e) Allowing the molecules to travel for a sufficient time after acceleration so that the molecules are able to be separated as a consequence of their differences in velocity;
f) Inducing an emission from the molecules in a localized area of the path of travel after time for separation has elapsed;
g) Detecting the emissions from the molecules.

A detailed description of each of the steps listed above will now be given generally in the order that they are presented.

In an example embodiment, nucleic acid that is to be analyzed is prepared by producing copies ranging in length from a few nucleotides up the same length as the original sample molecule. When these copies are produced care is taken so as to produce generally equivalent numbers of molecules of each given length. At the end of each molecule, a fluorescent dye is incorporated in place of the original nucleotide. Four different dyes are used in the preparation of the copies, one for each of the four possible nucleotides. Each of these dyes has unique emission spectra when induced by external means such as illumination by a light source such as a laser.

There are various techniques for preparing the samples to achieve the desired results mentioned above. The most common method involves the use of the enzymatic chain termination reaction. This method is widely used and well known. This technique involves the Polymerase Chain Reaction (PCR) to make copies of the original sequence. During the copying, a dideoxynucleotide with a fluorescent dye molecule attached is incorporated randomly during PCR this halts the copying of the chain at the point where it is incorporated. Sufficient PCR cycles are run so that large enough populations of base specific terminated fragments of different lengths exist to allow detection by the detector as described later in this disclosure. This process is generally referred to as a sequencing reaction. This method of preparation is commonly used in preparing molecules for sequencing using electrophoresis. Several variations of this technique exist, are well known and are mostly based on methods proposed by Sanger, F., Nicken, S. and Coulson, A. R. Proc. Natl. Acad. Sci. USA 74, 5463 (1977) and the methods proposed by Maxam, A. M. and Gilbert, W. Methods in Enzymology 65, 499-599 (1980).

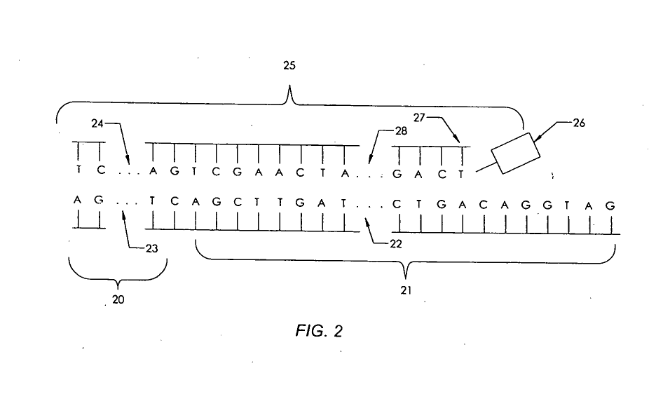

Referring to the example embodiment in FIG. 2, a schematic view is shown of a short strand of DNA prepared using a sequencing reaction. 21 represents the original sequence of nucleotides that is to be analyzed. The ellipses 22, 23, 24 and 28 indicate the positions of an arbitrary number of intervening bases that are not shown due to space limitations in the drawing. The bases shown in this view are A representing adenine, C representing cytosine, G representing guanine and T representing thymine. The particular sequence shown has no particular significance and was chosen randomly for the purposes of illustration only. The invention does not depend upon any specific bases or number of bases in the molecule under analysis. 20 represents the primer region. The strand shown generally at 25 above and complementary to the original sequence represents the copy of the original sequence generated by PCR. The molecule is shown in the state after the polymerase has completed the copying of the original sequence 21 and the polymerization has been, in an example embodiment, terminated by molecule 27. The terminating molecule 27 has label 26 attached to it. In the case shown, the terminating molecule is shown as a T and is complimentary to the corresponding molecule A on the original sequence.

In the example embodiment, the terminating molecule 27 that is incorporated is a dideoxynucleotide with a fluorophore molecule 26 attached to it. The terminating molecule 27 is shown as a T in this case since T is complimentary to A; this example embodiment was chosen for illustration. The tag molecule 26 in this case is a fluorophore. It emits light when stimulated by an external source such as a laser. The emission spectrum of this molecule is chosen to be unique for the particular terminating molecule that it is attached to. For example the terminating molecule that is complementary to A will have a unique fluorophore that will have a unique emission spectra to the fluorophore that is attached to the terminating molecule complimentary to T and likewise unique for C and G. This allows each terminating molecule to be uniquely identified when stimulated so that they can be differentiated from the other bases. The tag molecule 26 could alternatively be a chromophore or any molecule that will emit a detectable emission when stimulated by an external source and that can be uniquely distinguished from the emissions of the other tag molecules in the sample. The present discussion refers to the analysis of DNA and the bases present therein, however, RNA could be analyzed in a similar fashion. In the case of RNA, it would be necessary to use a terminating molecule that would be complimentary to Uracil and use a polymerase appropriate for the reaction. The present invention is not intended to be limited only to the sequencing of DNA.

During the sequencing reaction, a sufficient number of copies of the original sequence are generated to provide sufficient signal for the detector when stimulated. As the molecules are synthesized by the polymerase, the terminating molecules are randomly incorporated which halts extension. The reaction is prepared to produce a generally uniform quantity of copies ranging from the first base to the entire length of the original molecule.

The example sequencing reaction for the present invention makes uses of the polymerase chain termination reaction however; any method that yields copies of the original sequence that can be distinguished from the other terminating molecules representing a different base is acceptable. What is important for the process is to have one or more copies of the original sequence for each base in the original sequence and that each copy has a length representative of the position that each base occupies. For example if a molecule having 5 bases were to be analyzed there should be at least 5 molecules with lengths of 1, 2, 3, 4 and 5 nucleotides. Each of the 5 molecules will have a terminating molecule that is complimentary to the original base at the terminating position in the original molecule. The terminating position refers to the position of the base at the location where copying was terminated.

In chain terminator sequencing (Sanger sequencing), extension is initiated at a specific site on the template DNA by using a short oligonucleotide ‘primer’ complementary to the template at that region. The oligonucleotide primer is extended using a DNA polymerase, an enzyme that replicates DNA. Included with the primer and DNA polymerase are the four deoxynucleotide bases (DNA building blocks), along with a low concentration of a chain terminating nucleotide (most commonly a di-deoxynucleotide). Limited incorporation of the chain terminating nucleotide by the DNA polymerase results in a series of related DNA fragments that are terminated only at positions where that particular nucleotide is used. The fragments are then size-separated by electrophoresis in a slab polyacrylamide gel, or more commonly now, in a narrow glass tube (capillary) filled with a viscous polymer.

The classical chain termination method or Sanger method first involves preparing the DNA to be sequenced as a single strand. The DNA sample is divided into four separate samples. Each of the four samples have a primer, the four normal deoxynucleotides (dATP, dGTP, dCTP and dTTP), DNA polymerase, and only one of the four dideoxynucleotides (ddATP, ddGTP, ddCTP and ddTTP) added to it. The dideoxynucleotides are added in limited quantities. In an example embodiment, the primer or the dideoxynucleotides are either radiolabeled or have a fluorescent tag.

As the DNA strand is elongated the DNA polymerase catalyses the joining of deoxynucleotides to the corresponding bases. However, if a dideoxynucleotide is joined to a base, then that fragment of DNA can no longer be elongated since a dideoxynucleotide lacks a crucial 3′-OH group. Fragments of all sizes should be obtained due to the randomness of when a dideoxynucleotide is added. However, to make sure that all different lengths will occur, only short stretches of DNA can be sequenced in one test.

The DNA is then denatured and the resulting fragments are separated (with a resolution of just one nucleotide) by gel electrophoresis, from longest to shortest. The shorter fragments have greater mobility in the gel than the longer fragments and therefore arrive at the detector first with successively longer fragments following. Each of the four DNA samples is run on one of four individual lanes (lanes A, T, G, C) depending on which dideoxynucleotide was added. Depending on the whether the primers or dideoxynucleotides were radiolabeled or fluorescently labeled, the DNA bands can be detected by exposure to X-rays or UV-light and the DNA sequence can be directly read off the gel. Bands in the gel indicate the positions of the DNA molecules of different lengths. A band in a lane indicates a chain termination for that particular DNA subunit and the DNA sequence can be read off accordingly.

There can be various problems with sequencing through the Sanger Method. The primer used can also be annealed to a second site. This would cause two sequences to be interpreted at the same time. This can be solved by higher annealing temperatures and higher G and C content in the primer. Another problem can occur when RNA contaminates the reaction, which can act like a primer and leads to bands in all lanes at all positions due to non specific priming. Other contaminants can be from other plasmids, inhibitors of DNA polymerase, and low concentrations of template in general. Secondary structure of DNA being read by DNA polymerase can lead to reading problems and will be visualized on the readout by bands in all lanes of only a few positions.

There are two sub-types of chain-termination sequencing. In the original method, the nucleotide order of a particular DNA template can be inferred by performing four parallel extension reactions using one of the four chain-terminating bases in each reaction. The DNA fragments are detected by labeling the primer with radioactive phosphorous prior to performing the sequencing reaction. The four reactions would then be run out in four adjacent lanes on a slab polyacrylamide gel.

A development of this method used four different fluorescent dye-labeled primers. This has the advantage of avoiding the need for radioactivity; increasing safety and speed, and also that the four reactions can be combined and run in a single gel lane, if they can be distinguished. This approach is known as ‘dye primer sequencing’.

An alternative to the labeling the primer is to label the terminators instead, commonly called ‘dye terminator sequencing’. The major advantage of this approach is the complete sequencing set can be performed in a single reaction, rather than the four needed with the labeled-primer approach. This is accomplished by labeling each of the dideoxynucleotide chain-terminators with a separate fluorescent dye, which fluoresces at a different wavelength. This method is easier and quicker than the dye primer approach, but may produce more uneven data peaks (different heights), due to a template dependent difference in the incorporation of the large dye chain-terminators. This problem has been significantly reduced with the introduction of new enzymes and dyes that minimize incorporation variability.

This method is now used for the vast majority of sequencing reactions as it is both simpler and cheaper. The major reason for this is that the primers do not have to be separately labeled (which can be a significant expense for a single-use custom primer), although this is less of a concern with frequently used ‘universal’ primers.

To produce detectable labeled products from the template DNA, ‘cycle sequencing’ is most commonly performed. This approach uses repeated (25-40) rounds of primer annealing, DNA polymerase extension and disassociation (melting) of the template DNA strands. The major advantages of cycle sequencing is the more efficient use of the expensive sequencing reagent (BigDye) and the ability to sequence templates with strong secondary structures such as hairpins or GC-rich regions. The different stages of cycle sequencing are performed by altering the temperature of the reaction using a PCR thermal cycler. This relies on the fact that complementary DNA will anneal at a lower temperatures and disassociate at higher temperatures. An important part of making this possible is the use of DNA polymerase from a thermophillic organism, which is not rapidly denatured at the high (>95 C) temperatures involved. In the past, new DNA polymerase had to be added individually every cycle of PCR.

Various large-scale sequencing strategies include several current methods which can directly sequence only short lengths of DNA at a time. For example, modern sequencing machines using the Sanger method can achieve a maximum of around 1000 base pairs. This limitation is due to the geometrically decreasing probability of chain termination at increasing lengths, as well as physical limitations on gel size and resolution.

It is often necessary to obtain the sequence of much larger regions. For example, even simple bacterial genomes contain millions of base pairs, and the human genome has more than 3 billion. Several strategies have been devised for large-scale DNA sequencing, including primer walking (see also chromosome walking) and shotgun sequencing. These involve taking many small reads of the DNA through the Sanger method and subsequently assembling them into a contiguous sequence. The different strategies have different tradeoffs in speed and accuracy; for example, the shotgun method is the most practical for sequencing large genomes, but its assembly process is complex and potentially error-prone.

It is easier to obtain high quality sequence data when the desired DNA is purified and amplified from any contaminants that may be in the original sample. This can be achieved through PCR if it is practical to design primers that cover the entire desired region. Alternatively, the sample can be cloned using a bacterial vector, harnessing bacteria to “grow” copies of the desired DNA a few thousand base pairs at a time. Most large-scale sequencing efforts involve the preparation of a large library of such clones.

Certain areas of molecular biology research are very dependent upon identifying and sequencing RNA. RNA is less stable in the cell, and also more prone to nuclease attack experimentally. As RNA is generated by transcription from DNA, the information is already present in the cell's DNA. However, it is sometimes desirable to sequence RNA molecules. In particular, in Eukaryotes RNA molecules are not necessarily co-linear with their DNA template, as introns are excised. To sequence RNA, the usual method is first to reverse transcribe the sample to generate DNA fragments. This can then be sequenced as described above.

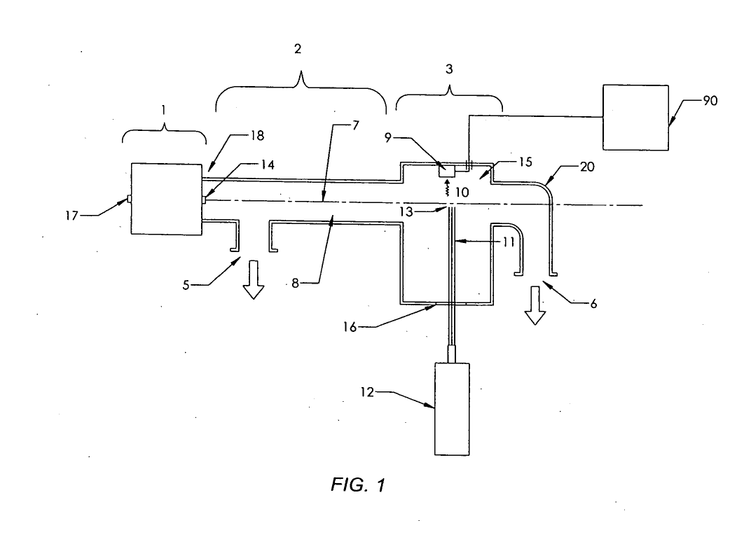

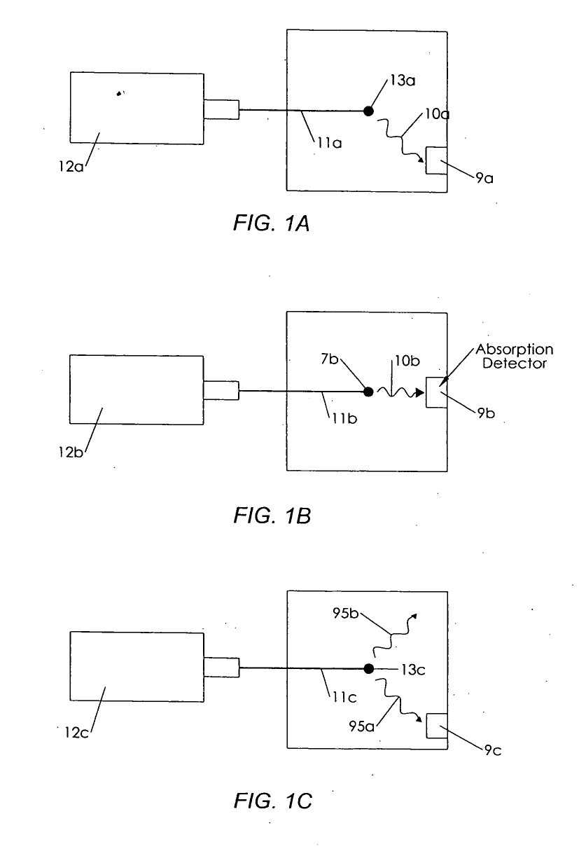

Referring to one example embodiment shown in FIG. 1, once a sample has been prepared, it is ready for use. An example embodiment of the present invention comprises a source of nucleic acid fragments each being distinguishable by its spectral characteristics as described above. The example embodiment further comprises a mass dependent molecule isolator which in the current embodiment comprises means for vaporization and acceleration of the nucleic acid fragments shown generally at 1; means 17 for introducing the nucleic acid fragments to the vaporization and acceleration means; a drift region 2 having two ends 18 and 19 and having the vaporization and acceleration means 1 located at one end 18 of the drift region and directed so that it propels the nucleic acid fragments through the drift region along the path generally represented by the dashed line 7; detecting means shown generally at 3 located at the end 19 of the drift region 2 generally opposite the accelerating and vaporization means 1. The detecting means 3 comprises means 12 for inducing emission from the nucleic acid fragments represented by the dashed line 7; and means 9 for detecting emissions from the tagged nucleic acid fragments, represented schematically by the wavy arrow 10 and distinguishing the tagged nucleic acid fragments. Referring again to FIG. 1, the vaporizing and accelerating means 1 in the example embodiment is an electrospray device. The purpose of this device is to vaporize the molecules of the sample and accelerate them to a velocity that is proportional to their masses. Typically with electrospray the molecules of the sample are vaporized, ionized and accelerated by an ion accelerator. The velocity that the molecules are accelerated to is proportional to their mass to charge ratio. Electrospray is a common technique used in mass spectrography for vaporizing and accelerating a sample to be analyzed and is well understood. U.S. Pat. No. 5,015,845 Allen et al., shows such a device. This patent is cited for reference; there are many different designs for this technique that will work well for the purposes of the present invention. Electrospray is used in the example embodiment because it accelerates large molecules without causing significant degradation of the molecules and because it lends itself to a continuous process. With electrospray, the sample can be introduced continuously to the device while maintaining the vacuum in the drift region. This means that the drift region 2 and detector 3 do not have to undergo periodic pump downs just to introduce more samples. This is highly desirable in achieving high throughput since it eliminates the down time that would be incurred if these chambers had to be pumped down periodically.

Vaporization and acceleration of the sample may be accomplished by many other methods. Other methods used for mass spectrography may be used providing different advantages as can be appreciated by those skilled in the art. Some of these methods are Matrix Assisted Laser Desorption Ionization, Fast-atom bombardment, Electron impact, Field ionization, Plasma-desorption ionization or Laser ionization. The particular technique is not important as long as the sample is vaporized so that the molecules are generally separated from each other and that the molecules all receive generally the same amount of energy during acceleration. Another important characteristic of the vaporization and acceleration means 1 is that vaporization and acceleration be accomplished without significant degradation of the sample molecules. Significant degradation of the sample for example, would be a situation in which the sample molecules were broken apart to a degree that prevented an accurate signal to be detected by the detection means 3. In this situation, the molecules would not be of the correct size to represent the position of the base nucleotide indicated by the attached tag. The molecule would then be accelerated to a velocity inappropriate for the base. Upon reaching the detector, they would contribute noise that would inhibit accurate determination of the base for that position. If the noise signal from the degraded molecules is greater than the proper signal, it would cause inaccurate detection.

Referring again to FIG. 1, each molecule in the sample is accelerated and allowed to travel down drift region 2 generally along the path indicated by dashed line 7. The drift region 2 has an chamber area 8 which is generally free of obstruction that would inhibit free travel of the molecules. The chamber 8 is maintained at sufficient vacuum so as not to cause collisions with stray molecules that might cause degradation of the sample molecules or significantly disturb the flight of the sample molecules. A vacuum port is shown generally at 5 and is connected to a vacuum pump capable of maintaining sufficient vacuum as described above. The location of this port is shown generally close to the exit port 14 of the vaporizing and accelerating means. This is to more efficiently remove stray molecules entering the chamber 8 through exit port 14. The sample molecules will be essentially unaffected. Alternatively, one or more vacuum pumps may be used and positioned anywhere along the drift region as long as they are capable of maintaining sufficient vacuum as described earlier.

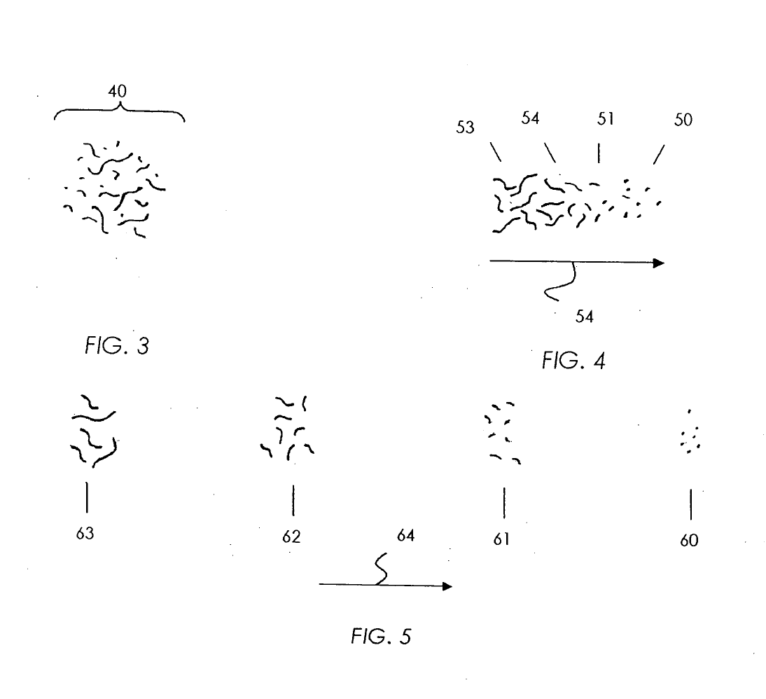

As the sample molecules travel down the drift region 2, the smaller (faster moving nucleic acid fragments) move ahead of the larger ones and are thereby sorted sequentially by size. FIG. 3 shows a hypothetical mixture of sample fragments generally at 40. The mixture is depicted symbolically to represent a mixture of randomly positioned fragments of different lengths. This is representative of the molecules after vaporization and immediately before acceleration. FIG. 4 shows the same molecules as depicted in FIG. 3 shortly after acceleration generally at 50, 51, 52 and 53. FIG. 4 illustrates symbolically the process of separation that occurs due to differing velocities of each different fragment length. The arrow 54 shows the general direction of travel of all of the molecules in the sample. The smallest molecules shown generally at 50 have begun to move ahead of the larger molecules shown generally at 51, 52 and 53. The same is true of the next smallest molecules 51, which are shown moving ahead of larger molecules at 52 and 53. Likewise, the molecules at 52 have begun to move ahead of the larger molecules at 53. FIG. 5 illustrates symbolically the same molecules depicted in FIGS. 3 and 4 but at a point in time sufficiently later to allow more complete separation of the molecules. The arrow 64 represents the general direction of travel of the molecules and each different size molecule is represented generally at 60, 61, 62 and 63 where the smallest molecules are depicted at 60, next largest at 61, next largest at 62 and largest at 63. At this point in time the differences in velocity of each different size molecule has caused a separation and sorting by size to occur. In reality the number of different sized molecules in the sample will usually be more than four as shown in FIGS. 3, 4 and 5; however it can be appreciated that for the purposes of illustration, this small number was chosen to more simply illustrate the separation process in a symbolic manner.

The length of the drift region 2 as shown in FIG. 1, is chosen to allow sufficient distance and time for the molecules to separate sufficiently to allow individual detection of each size molecule. The length of the drift region in the example embodiment is typically 1 to 2 meters but can be longer or shorter depending upon the velocity of the molecules and upon the type of molecule being analyzed. What is important is that the length be sufficient to allow sufficient separation of the molecules for accurate detection by the detector 3.

Referring again to FIG. 1, once the molecules reach the end of the drift region 19, they enter the detector 3. The detector of the example embodiment includes a vacuum chamber 15 that is generally contiguous with the chamber 8 of the drift region and a vacuum pump connected to port 6. The vacuum port 6 has a generally curved section 20 where the sample molecules strike after leaving the detector. The curvature of the port at 20 helps slow down the molecules and deflect them to the vacuum pump connected at 6.

The detector 3 also includes means for inducing emission from the sample nucleic acid fragments, which for the example embodiment is a laser 12. The laser 12 is directed through a transparent window 16 in the wall of the chamber and is aimed to intersect the flight path of the molecules 7 as shown generally at 13. The wavy arrow 10 is a symbolic representation of the emissions from the molecules as they are illuminated by the laser beam 11. In the case of the example embodiment, these emissions are photons. The laser has associated optics that focus and condition the emission inducing photons so that they illuminate the sample molecules in a sufficiently narrow region. The size of the region in the direction of travel of the molecules should be narrow enough to prevent significant illumination of neighboring molecules of different sizes and thus avoid stray signals that could give an erroneous reading. The width of the beam in the plane perpendicular to the flight path of the molecules should be sufficient to illuminate enough of the molecules to generate a detectable signal and maximize the signal to noise ratio. The wavelength of the laser is chosen to best coincide with the excitation maxima for all the fluorescent dye molecules in the sample and thus provide a reasonable compromise for optimal emission from all of the fluorophores.

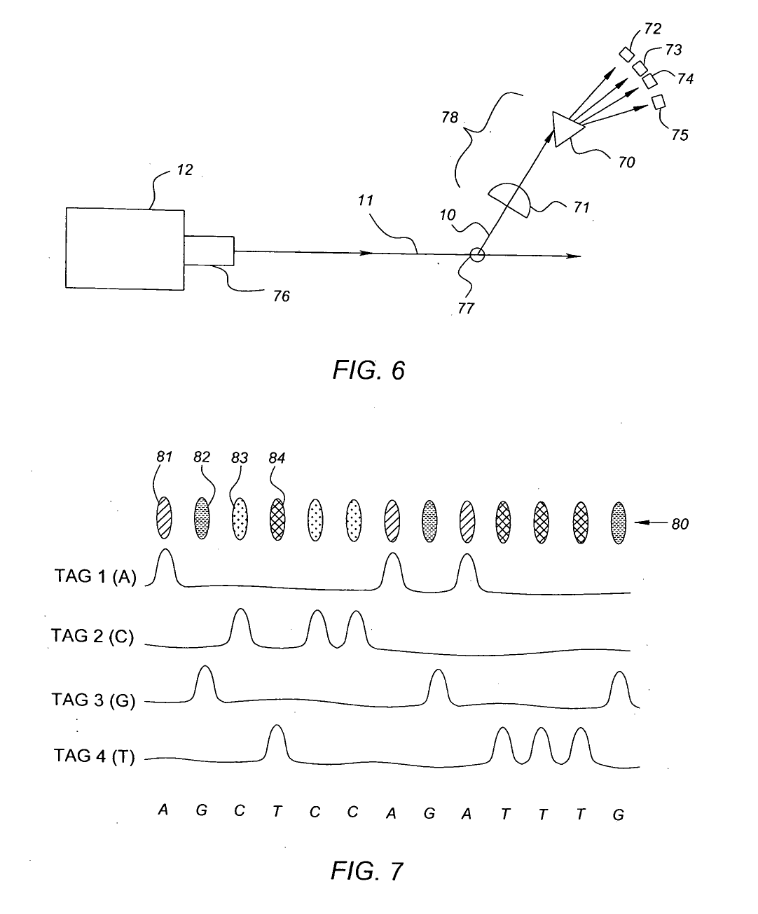

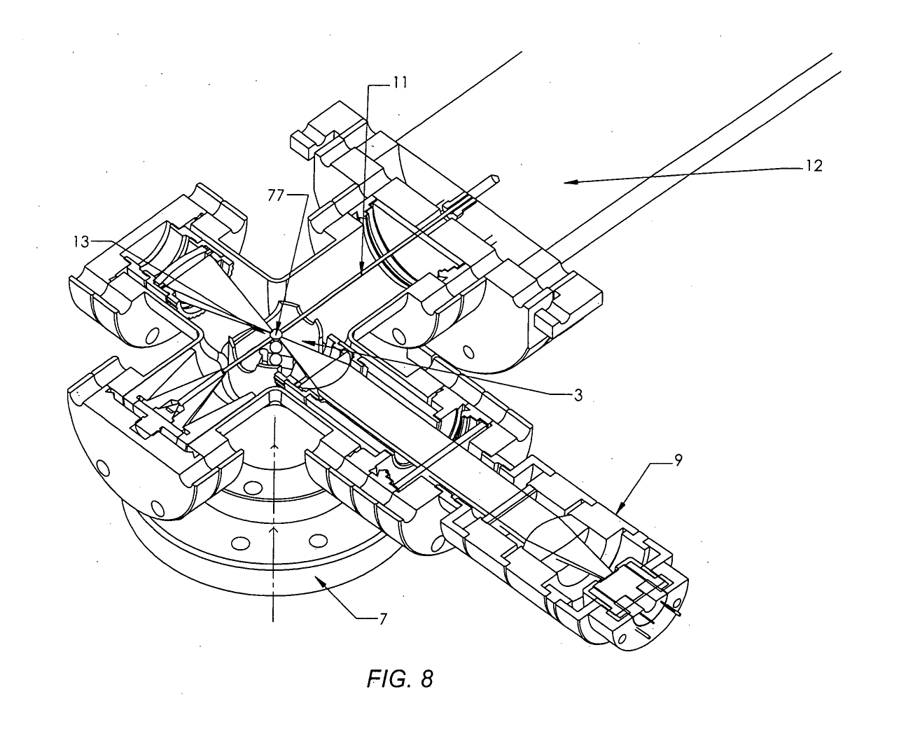

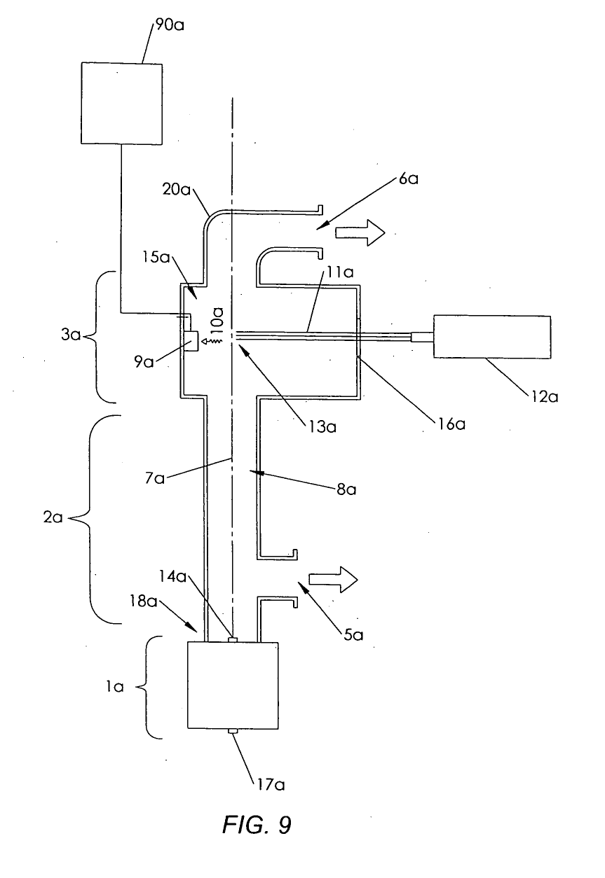

FIG. 6 shows a block diagram of the optics for a detector in accordance with the present invention. This view is shown looking parallel to a plane that is perpendicular to the flight path of the sample molecules 7 as shown in FIG. 1. Referring to FIG. 6, the laser 12 emits a beam of photons that are that focused and conditioned by optics 76 and is directed to illuminate the sample molecules 77. Some of the photons emitted from the sample are focused and separated into spectral bands by detector optics shown generally at 78. The detector optics shown in FIG. 6 includes a lens 71 and a prism 70. The lens focuses the beam and the prism separates the beam into spectral bands that then strike photomultiplier tubes 72, 73, 74 and 75.

FIG. 7 shows a hypothetical stream of molecules symbolically represented by the ovals generally at 80. Each molecule has a fill pattern that represents the particular tag present in that group of molecules. Group 81 is tagged with the molecule indicating A, group 82 is tagged with the molecule indicating C, group 83 is tagged with the molecule indicating G and group 84 is tagged with the molecule indicating T. Like fill indicates like tags. The lines below the stream labeled Tag 1 (A), Tag 2 (C), Tag 3 (G) and Tag 4 (T) are hypothetical outputs from each of the four detectors 72,73,74 and 75 that correspond to the tags on the molecules shown generally at 80 above. These outputs illustrate amplitude of the output signal vs. time for each detector. As each group of molecules pass through the laser, they are illuminated causing them to fluoresce. The light emitted passes through lens 71 is refracted by prism 70 and directed to one of the four photomultiplier tubes 72 through 75 depending upon the wavelength of light emitted.

The outputs from the photomultiplier tubes are fed into a computer having a high-speed interface to capture the data. As the data comes in from each input, the computer makes the conversion from input source to corresponding base and combines the data sequentially to yield the sequence of the original molecule under analysis. Since the molecules pass the detector in order of increasing size, the order of the out put signals is the same as the order of the original sequence being analyzed.

While for the purposes of disclosure and illustration, the example embodiment has been discussed in detail there are numerous other possible components that can be used in combination to achieve the same purposes and still fall within the scope of the invention. Some of these have been listed above and additional possibilities are listed below for illustration purposes.

An example embodiment of the invention has been explained for sequencing of nucleic acids such as DNA and RNA. Other example embodiments of the invention will be obvious to those skilled in the art and can be used for sequencing proteins or any polymer or chain type molecule. Common elements in the analysis are:
a) the molecules analyzed in the apparatus be duplicates of the original molecule;
b) the duplicates have some distinguishing characteristic representative of the original component molecule occupying the end position;
c) and the distinguishing characteristic be induced to emit some detectable signal that is differentiable from other distinguishing characteristics of the other component molecules being analyzed.

An example detection means for the invention comprises a laser to induce fluorescent emission from the molecules and a photomultiplier to detect these emissions. Other embodiments could use a light from a source such as an electric lamp, directed at the molecules and optical detectors to measure the absorption of light by the molecules. Still another embodiment might sense the emission from molecules tagged with different chromophores. Other embodiments could sense radio frequency emission from molecular tags that emit a distinguishable RF signal when stimulated. Still other embodiments of the detector could sense higher energy emissions such as X-rays when stimulated.

Some alternate methods of stimulation include electron beam, ion beam, and other electro magnetic radiation such as radio frequency, x-ray, ultra violet and gamma ray. High energy collisions with a surface could be used wherein the tag emits radiation of a differentiable spectrum when impact occurs. An example of this is a metal atom incorporated as a tag, and stimulation by a high-energy collision with a surface.

Some other example embodiments of methods of isolating the molecule to be analyzed include various techniques employed by mass spectrometry.

Mass spectrometry is an analytical technique used to measure the mass of molecules based on mass-to-charge ratio (m/q) of ions generated from the molecules. It is most generally used to find the composition of a physical sample by generating a mass spectrum representing the masses of sample components. Mass spectrometers do this by separating one or more molecules according to their mass and by detecting the molecules after the separation. Based on the detection and separation the mass can be determined. The technique has several applications, including:

a) identifying unknown compounds by the mass of the compound and/or fragments thereof.

b) determining the isotopic composition of one or more elements in a compound.

c) determining the structure of compounds by observing the fragmentation of the compound.

d) quantitating the amount of a compound in a sample using carefully designed methods (mass spectrometry is not inherently quantitative).

e) studying the fundamentals of gas phase ion chemistry (the chemistry of ions and neutrals in vacuum).

f) determining other physical, chemical or even biological properties of compounds with a variety of other approaches.

A mass spectrometer is a device used for mass spectrometry, and produces a mass spectrum of a sample to find its composition. This is normally achieved by ionizing the sample and separating ions of differing masses and recording their relative abundance by measuring intensities of ion flux. A typical mass spectrometer comprises three parts: an ion source, a mass analyzer, and a detector.

The ion source is the part of the mass spectrometer that ionizes the material under analysis (the analyte). The ions are then transported by magnetic or electrical fields to the mass analyzer.

Techniques for ionization have been key to determining what types of samples can be analyzed by mass spectrometry. Electron ionization and chemical ionization are used for gases and vapors. In chemical ionization sources, the analyte is ionized by chemical ion-molecule reactions during collisions in the source. Two techniques often used with liquid and solid biological samples include electrospray ionization (due to John Fenn) and matrix-assisted laser desorption/ionization (MALDI, due to M. Karas and F. Hillenkamp). Inductively coupled plasma sources are used primarily for metal analysis on a wide array of samples types. Others include fast atom bombardment (FAB), thermospray, atmospheric pressure chemical ionization (APCI), secondary ion mass spectrometry (SIMS) and thermal ionization.

Mass analyzers separate the ions according to their mass-to-charge ratio (m/q). All mass spectrometers are based on dynamics of charged particles in electric and magnetic fields in vacuum where the following to laws apply:

F=q(E+v×B), (Lorentz force law)

F=ma(Newton's second law of motion)

where F is the force applied to the ion, m is the mass of the ion, a is the acceleration, q is the ionic charge, E is the electric field, and v×B is the vector cross product of the ion velocity and the magnetic field.

Using Newton's third law of motion yields:

(m/q)a=E v×B

This differential equation is the classic equation of motion of charged particles. Together with the particles initial conditions it completely determines the particles motion in space and time and therefore is the basis of every mass spectrometer. It immediately reveals that two particles with the same physical quantity m/q behave exactly the same. This is why all mass spectrometers actually measure m/q and strictly speaking should be called mass-to-charge spectrometers. In mass spectrometry it is very common to use the dimensionless m/z, where z is the number of elementary charges (e)on the ion (z=q/e) instead of the mass-to-charge ratio m/q.

There are many types of mass analyzers, some using static fields, some using dynamic fields, some using magnetic fields, some using electric fields, but all operate according this same law. Several examples are provided as follows:

a) Section MS: It uses an electric and/or magnetic field to affect the path and/or velocity of the charged particles in some way. As shown above, sector instruments change the direction of ions that are flying through the mass analyzer. The ions enter a magnetic or electric field which bends the ion paths depending on their mass-to-charge ratios (m/q), deflecting the more charged and faster-moving, lighter ions more. The ions eventually reach the detector and their relative abundances are measured. The analyzer can be used to select a narrow range of m/q's or to scan through a range of m/q's to catalog the ions present.

Besides the original magnetic-sector analyzers, several other types of analyzer are now more common, including time-of-flight, quadrupole ion trap, quadrupole and Fourier transform ion cyclotron resonance mass analyzers.

b) TOFMS: Perhaps the easiest to understand is the Time-of-flight (TOF) analyzer. It boosts ions to the same kinetic energy by passage through an electric field and then measures the times they take to reach the detector. While the nominal kinetic energy of all the ions is the same, the resultant velocity is different, thereby causing lighter ions (and also more highly charged ions) to reach the detector first.

c) QMS: Quadrupole mass analyzers use oscillating electrical fields to selectively stabilize or destabilize ions passing through a RF quadrupole field.

d) QIT: The quadrupole ion trap works on the same physical principles as the QMS, but the ions are trapped and sequentially ejected. Ions are created and trapped in a mainly quadrupole RF potential and separated by m/q, non-destructively or destructively. There are many mass/charge separation and isolation methods but most commonly used is the mass instability mode in which the RF potential is ramped so that the orbit of ions with a mass a>b are stable while ions with mass b become unstable and are ejected on the z-axis onto a detector. Ions may also be ejected by the resonance excitation method, whereby a supplemental oscillatory excitation voltage is applied to the endcap electrodes, and the trapping voltage amplitude and/or excitation voltage frequency is varied to bring ions into a resonance condition in order of their mass/charge ratio. The cylindrical ion trap mass spectrometer is a derivative of the quadrupole ion trap mass spectrometer.

e) Linear QIT: In the linear quadrupole ion trap the ions are trapped in a 2D quadrupole field instead of the 3D quadrupole field of the QIT.

f) FTICR: Fourier transform mass spectrometry or more precisely Fourier transform ion cyclotron resonance mass spectrometry measures mass by detecting the image current produced by ions cyclotroning in the presence of a magnetic field. Instead of measuring the deflection of ions with a detector such as a electron multiplier, the ions are injected into a Penning trap (a static electric/magnetic ion trap) where they effectively form part of a circuit. Detectors at fixed positions in space measure the electrical signal of ions which pass near them over time producing cyclical signal. Since the frequency of the ions' cycling is determined by its mass to charge ratio, this can be deconvoluted by performing a Fourier transform on the signal. FTMS has the advantage of improved sensitivity (since each ion is ‘counted’ more than once) as well as much higher resolution and thus precision.

g) ICR: Ion cyclotron resonance is an older mass analysis technique that is similar to FTMS above except ions are detected with a traditional detector. Ions trapped in a Penning trap are excited by an RF electric field until they impact the wall of the trap where the detector is located with ions of different mass being resolved in time.

h) Orbitrap: Orbitraps are the most recently introduced mass analyzers (commercially available since 2005). Ions are electrostatically trapped in an orbit around a central, spindle-shaped electrode. They perform two kinds of movements in parallel: First, they cycle in an orbit around the central electrode. Second, they also move back and forth along the axis of the central electrode. Thus, the ion movement resembles a ring that oscillates along the axis of the spindle. This oscillation generates an image current in detector plates which is recorded. The frequencies of these image currents depend on the mass to charge ratios of the ions in the Orbitrap. Mass spectra are obtained by Fourier transformation of the recorded image currents. Similar to Fourier transform ion cyclotron resonance mass spectrometers, Orbitraps have a high mass accuracy, high sensitivity and an increased dynamic range.

Each of the above analyzer types has its strengths and weaknesses. In addition, there are many more less-common mass analyzers. Many mass spectrometers use two or more mass analyzers for tandem mass spectrometry (MS/MS).

The final element of the mass spectrometer is the detector. The detector records the charge induced or current produced when an ion passes by or hits a surface. In a scanning instrument the signal produced in the detector during the course of the scan versus where the instrument is in the scan (at what m/q) will produce a mass spectrum, a record of how many ions of each m/q are present.

Typically, some types of electron multiplier is used, though other detectors (such as Faraday cups) have been used. Because the number of ions leaving the mass analyzer at a particular instant is typically quite small, significant amplification is often necessary to get a signal. Microchannel Plate Detectors are commonly used in modern commercial instruments. In FTMS, the detector consists of a pair of metal plates within the mass analyzer region which the ions only pass near. No DC current is produced, only a weak AC image current is produced in a circuit between the plates.

Another example embodiment runs 4 differently tagged molecule groups simultaneously. The different emissions from the different tags distinguish between A, C, G and T. Alternately, a single tagged molecule group could be run and the output data could then be combined afterwards to achieve the same results as running 4 simultaneously. Likewise, any combination of tagged molecule groups could be run together to obtain data for the molecules represented by the tags.

The invention is well suited to fulfill the objects of the invention. Since the molecules to be analyzed are accelerated to a high velocity to effect separation, the travel time through the apparatus is very short, on the order of 10⁻⁶ seconds. Therefore, the time to analyze a single sample is very small. The samples can be loaded into the vaporizer and accelerator in a way such that the vacuum can be maintained and the next sample can be introduced as soon as the previous sample has fully passed the detector. Once the sample is detected, it enters a scrubbing area where it is deflected and immediately removed by the vacuum pump. This allows almost a continuous flow of samples to be run through the apparatus, which allows for very high throughput.

The present invention may or may not rely upon impact type detectors like a micro channel device. In one example embodiment, the present invention does not rely upon impact type detectors like a micro channel device. This means that the detector life does not degrade as a function of sample molecules being run. This provides for significantly longer detector life, higher throughput and the reduction of down time.

In addition, the sequence determination may or may not be dependant upon very precise measurements of differences in arrival times of the molecules to distinguish between terminating molecules. In one example embodiment, the sequence determination is not dependant upon very precise measurements of differences in arrival times of the molecules to distinguish between terminating molecules. As molecule size increases the difference in mass between different terminating molecules becomes a very small difference compared to the total mass of the molecule. This makes differentiation much more difficult for larger molecules. Differentiation of the terminating molecule in the present invention is not dependant upon precise measurements in arrival time and therefore is not subject to the problems encountered by mass spectrometry. The present invention is therefore, well suited to determine the sequence of larger molecules with greater accuracy than before.

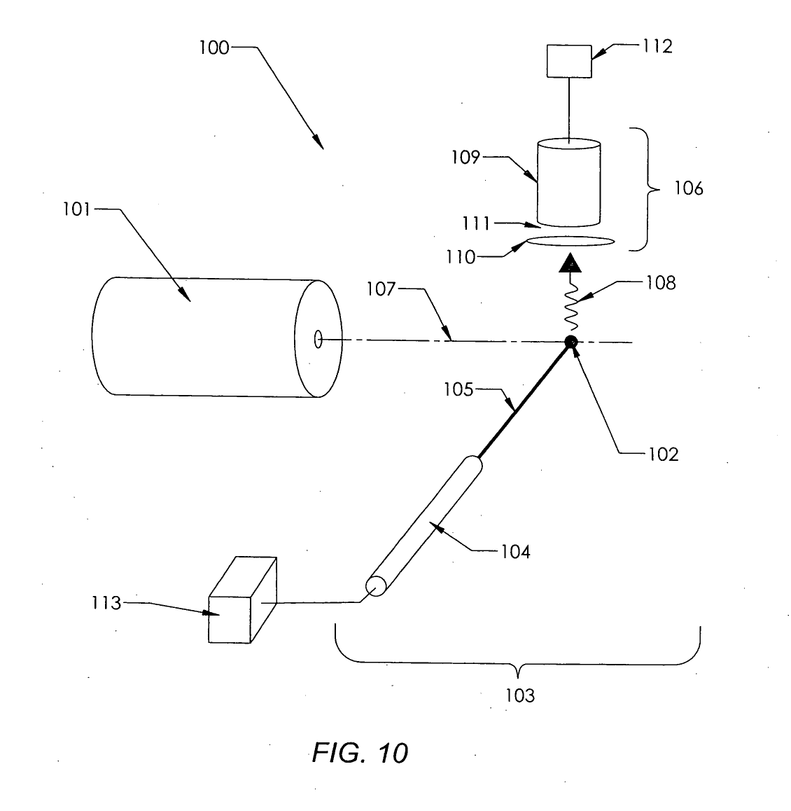

FIG. 10 shows an example embodiment apparatus 100 for analyzing at least one molecule 102 the apparatus comprises: A mass dependent molecule isolator 101 adapted to isolate at least one molecule wherein the isolation depends substantially on the mass of the at least one molecule; a molecule detector 103 in communication with the isolator the molecule detector comprises: at least one source of a radiant signal inducer 104 wherein the radiant signal inducer 105 is emitted continuously from the at least one source and; a signal detector 106 comprising at least one wavelength dependent photon detector.

The mass dependent molecule isolator 101 in the present embodiment is a time of flight mass analyzer. It uses an electric field to accelerate ionized molecules through the same potential, and then allows them to drift. If the particles all have the same charge, then their kinetic energies will be identical, and their velocities will depend only on their masses. Lighter ions will reach the detector first. Molecules will therefore be isolated depending substantially upon their mass.

The at least one molecule 102 is accelerated in the molecule isolator 101 and allowed to drift along flight path 107 until it reaches the molecule detector 103 where the radiant signal inducer 105, a laser beam, intersects the flight path and interacts with the molecule 102. At least one photon 108 is emitted from the molecule 102 as a result of the interaction of the molecule and the signal inducer. The laser beam is emitted from the source of a radiant signal inducer 104 which is a continuous wave laser in the current embodiment and comprises a control system 113. Continuous emission of the radiant signal inducer from the source ensures interaction with the molecule being analyzed and obviates the need for additional control circuitry to ensure proper interaction.

The photon 108 is detected by the signal detector 106. Data from the signal detector is collected by data collector 112. The signal detector comprises a wavelength dependent photon detector which comprises a photomultiplier tube 109 and a filter 110 placed in front of the photon receiving portion 111 of the photomultiplier tube. The filter 110 provides the ability to selectively detect photons depending upon the wavelength of the photon.

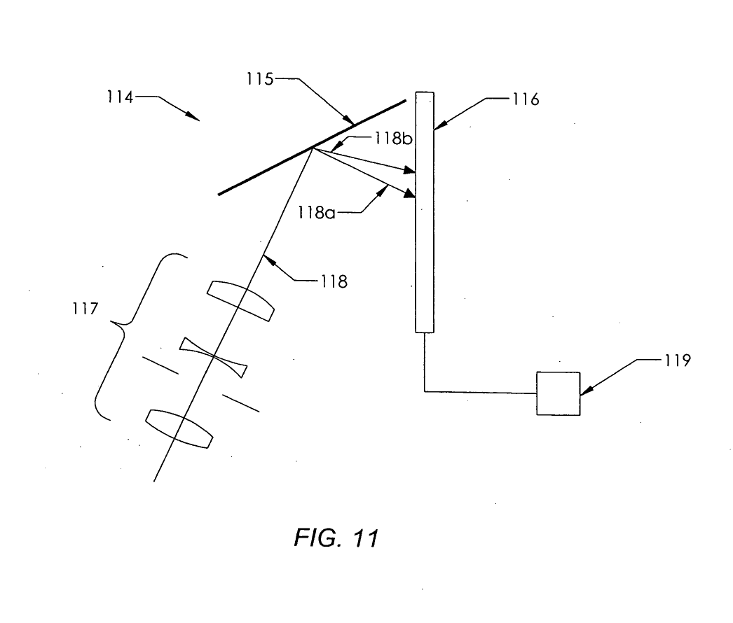

Other embodiments of a wavelength dependent photon detector may be used in the current in invention to accomplish the same result. Another example wavelength dependent photon detector is shown in FIG. 11 generally at 114 and comprises a diffraction grating 115, a charge coupled device (CCD) 116, collimating optics 117 and data collection system 119. The one or more photons enter the collimating optics 117 and are collimated into a beam 118 which strikes diffraction grating 115. The diffraction grating directs photons of different wavelengths 118a and 118b to different locations on the CCD where they generate a signal that is collected by the data collection system 119. The data from the data collection system then can be selectively used depending upon the wavelength detected as needed. Another example wavelength dependent photon detector is shown in FIG. 6 comprising detector optics shown generally at 78 including a lens 71 and prism 70. The lens collimates the signal beam 10 and the prism 70 refracts the signal beam depending upon the wavelength of the photons comprising it. Photomultiplier tubes 72, 73, 74 and 75 are placed appropriately to receive photons of the desired wavelength.

While the current embodiment mass dependent molecule isolator comprises time of flight mass analyzer other mass analyzers may be substituted to accomplish the same result. Other example mass dependent isolators include a quadrupole mass analyzer and a magnetic-sector mass analyzer.

The current embodiment radiant signal inducer comprises light from a continuous wave laser however further embodiments may comprise other signal inducers as will occur to those skilled in the art for analysis of a particular molecule of interest. Some examples of other signal inducers include particles and other electromagnetic radiation.

The example embodiment shown in FIG. 10 comprises a method for analyzing at least one molecule. this method comprises Isolating at least one molecule wherein said isolating depends substantially on the mass of the at least one molecule; subsequently Interacting the at least one molecule with a radiant signal inducer 105 wherein the radiant signal inducer is emitted continuously from at least one source 104; causing the at least one molecule to emit at least one photon 108 and detecting the at least one photon. The isolating step is performed by mass dependent molecule isolator 101. The Interacting step occurs when molecule 102 travels along flight path 107 and is struck by radiating signal inducer 105. The step of causing the at least one molecule to emit a photon happens as a result of the interaction of the radiating signal inducer and the molecule interaction. The detecting step happens as a result of the emitted photon 108 striking the signal detector 106.

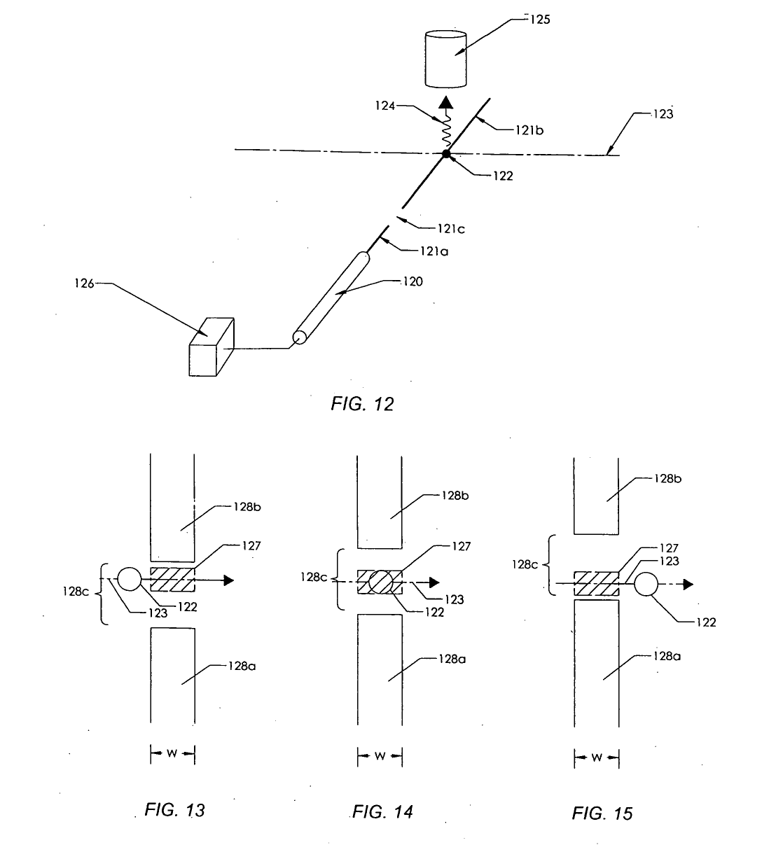

Another example embodiment comprises a mass dependent molecule isolator adapted to isolte at least one molecule wherein the isolation depends substantially on the mass of the at least one molecule and a molecule detector in communication with the isolator. The molecule detector of the current embodiment is shown in FIG. 12 comprises: at least one source of a radiant signal inducer 120, wherein the radiant signal inducer is emitted from the at least one source and comprises at least two on-pulses 121a and 121b separated by an off-pulse 121c; a duration control system 126 to control the duration of the off-pulse 121c to be less than the time that the at least one molecule 122 is in a position to interact with the signal inducer as it travels along flight path 123; a photon discriminator 125 comprising at least one wavelength dependent photon detector.

The present invention comprises a pulsed radiant signal inducer. A pulsed radiant signal inducer is generated by a pulsed source. A pulsed source in some cases includes advantages such as improved signal to noise ratio and a reduction in component cost. Lower cost components can be used in some instances since a higher power output can be achieved operating in pulsed mode rather than in continuous mode for a given size source.

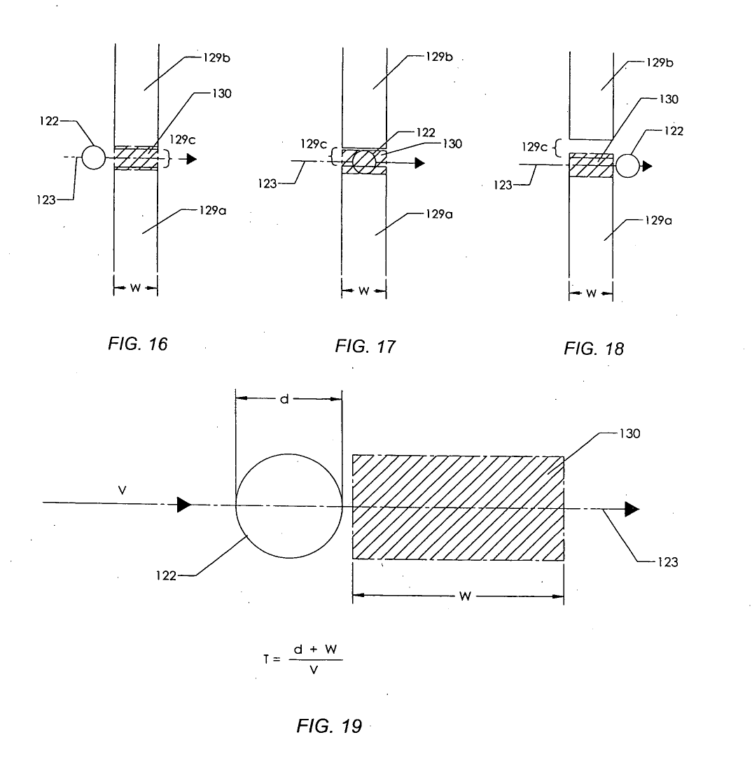

When a pulsed radiant signal inducer is used there is a chance of the molecule to be analyzed passing through the detector without interacting with the radiant signal inducer as illustrated in FIGS. 13 and 14 and 15. FIGS. 13, 14 and 15 show an enlarged view of the region where the molecule 122 is in a position to interact with the signal inducer pulses 128a and 128b. The series of figures show a sequence time slices where molecule 122 passes through the region where interaction with the signal inducer is possible but does not occur because the molecule passes through this region at the same time the off-pulse passes through the region. FIG. 13 shows molecule 122 traveling along flight path 123 and beginning to enter the interaction region 127. Signal inducer pulse 128b has just left the interaction region and signal inducer pulse 128a has not yet arrived. FIG. 14 shows molecule 122 midway through the interaction region 127 while signal inducer pulse 128a is still approaching the interaction region but has still not arrived. FIG. 15 shows molecule 122 exiting the interaction region 127 just before signal inducer pulse 128a enters the interaction region. These series of figures illustrate how a molecule can miss interaction with the radiant signal inducer if the duration of the off-pulse is greater than the time that the molecule 122 is in a position 127 to interact with the signal inducer as the molecule travels along its flight path 123. FIGS. 16, 18 and 19 show similar views to those of FIGS. 13, 14 and 15 however they illustrate the effect of an off-pulse time less than the time that the molecule is in a position to interact with the signal inducer as it travels along its flight path. FIG. 16 shows molecule 122 traveling along flight path 123 and beginning to enter the interaction region 130. Signal inducer pulse 129b is still in the interaction region and signal inducer pulse 129a is just arriving. FIG. 14 shows molecule 122 midway through the interaction region 130 while signal inducer pulse 129a is midway through the interaction region while pulse 129b is just leaving the interaction region. FIG. 15 shows molecule 122 exiting the interaction region 130 and still interacting with signal inducer pulse 129a. Thus by controlling the duration of the off-pulse so that it is less than the time that the molecule is in a position to interact with the radiant signal inducer detection of the molecule can be ensured.

For one example embodiment the time that the molecule is in a position to interact with the radiant signal inducer can be calculated as shown in FIG. 19. W is the width of the interaction region which in the present embodiment is the width of the signal inducing beam; d is the diameter of the molecule and v is the velocity of the velocity along the flight path 123. The time T can be calculated as shown in the formula in FIG. 19.

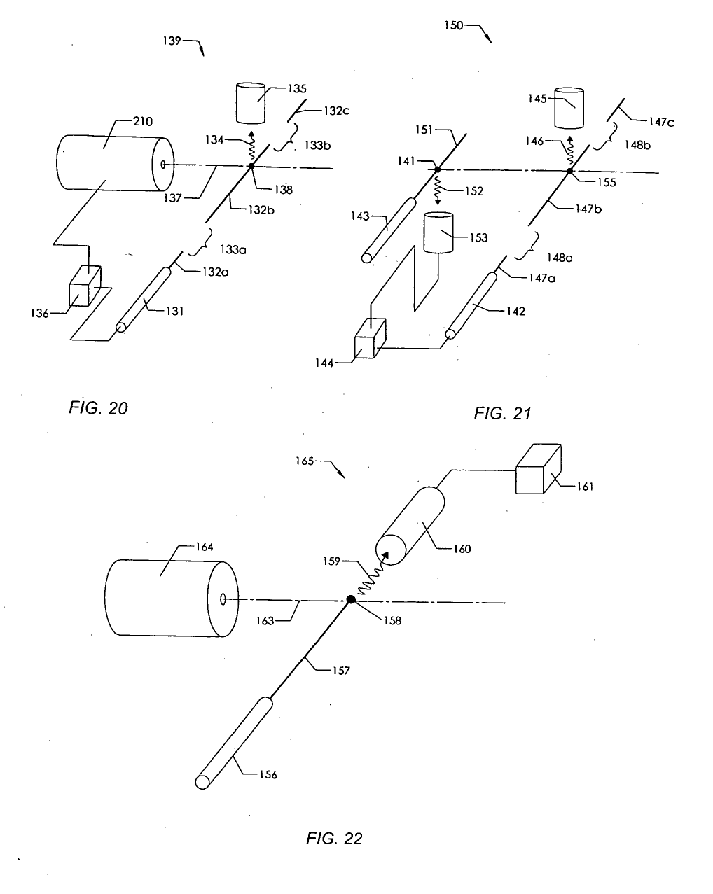

An alternate example embodiment molecule detector for use with a pulsed radiant signal inducer is shown in FIG. 20 generally at 139 and comprises: at least one source of a radiant signal inducer 131 wherein the radiant signal inducer is emitted from the at least one source and comprises at least two off-pulses 133a and 133b separated by an on-pulse 132b; a timing control system 136 to time the emission of the at least one on-pulse 132b of the signal inducer to allow interaction with the at lest one molecule 138; and a photon discriminator 135 comprising at least one wavelength dependent photon detector. In the present embodiment the molecule is isolated by the mass dependent molecule isolator 210 and travels along flight path 137. The timing control system receives a signal from the mass dependent molecule isolator 210 which is then used to time the emission of the at least one on-pulse 132b of the signal inducer to allow interaction with the at lest one molecule 138. Without the timing control circuit, the on-pulse might not properly interact with the molecule and proper detection of the signal from the molecule might not occur.

FIG. 20 shows an example embodiment apparatus comprising a method for analyzing a property of at least one molecule. The current example embodiment method comprises: Isolating at least one molecule 138 wherein said isolating depends substantially on the mass of the at least one molecule; subsequently Interacting the at least one molecule 138 with a radiant signal inducer 132b, wherein the signal inducer is emitted from at least one source 131 and comprises at least two off-pulses 133a and 133b separated by an on-pulse 132b, wherein the interacting further comprises: determining when the at least one molecule will be in a position to interact with the signal inducer and timing the emission of the at least one on-pulse 132b of the signal inducer to allow interaction with the at lest one molecule 138 based on said determining; detecting a signal 134 emitted from the at least one molecule resulting from the interacting of the at least one molecule and the radiant signal inducer 132b. The step of isolating is performed by the mass dependent molecule isolator 210. The step of interacting is performed by the travel of the molecule 138 along flight path 137 and intersecting the path of the radiant signal inducer 132b and the determining and emission timing steps of the interacting step are performed by the timing control system 136. The detecting step is performed by the photon discriminator 135.

FIG. 12 illustrates a detector for a further example embodiment comprising a method for analyzing a property of at least one molecule the method comprises: Isolating at least one molecule wherein said isolating depends substantially on the mass of the at least one molecule; subsequently Interacting the at least one molecule with a radiant signal inducer 121b, wherein the signal inducer is emitted from at least one source 120 and comprises at least two on-pulses 121a and 121b separated by an off-pulse 121c, wherein the interacting comprises: determining the amount of time that the at least one molecule will be in a position to interact with the signal inducer and controlling the off-pulse duration to be less than the time that the at least one molecule is in a position to interact with the signal inducer; detecting a signal emitted from the at least one molecule resulting from the interacting of the at least one molecule and the radiant signal inducer. The Isolating step is performed by a mass dependent molecule isolator. The interacting step is performed by the motion of the molecule along flight path 123 so as to intersect the path of the radiating signal inducer 121b. The determining step can be performed by the manufacturer, the user of the apparatus or automatically by the apparatus of the current embodiment. The step of controlling the off-pulse duration is performed by the duration control system 126. The step of detecting is performed by the photon discriminator 125.

FIG. 21 shows another alternate example embodiment molecule detector for use with a pulsed radiant signal inducer generally at 150. This embodiment comprises: at least one source of a radiant signal inducer 142 wherein the radiant signal inducer is emitted from the at least one source and comprises at least two off-pulses 148a and 148b separated by an on-pulse 147b; a timing control system 144 to time the emission of the at least one on-pulse 147b of the signal inducer to allow interaction with the at least one molecule 140; and a photon discriminator 145 comprising at least one wavelength dependent photon detector. The present embodiment also comprises a second source of a radiant signal inducer 143 that emits a continuous beam of a radiant signal inducer 151 and is directed to intersect the flight path 149 of the molecules at detection point 154. A second molecule 141 is shown at detection point 154 and emits a signal 152 when interacted with radiant signal inducer 151. Signal 152 is detected by detector 153. The signal from detector 153 is communicated to the timing control system 144 and is used to time the emission of the at least one on-pulse to interact properly with the molecule 141 detected at 154 when it arrives at 155

FIG. 22 shows an example embodiment molecule detector generally at 165 in communication with the mass dependent molecule isolator 164 comprising; at least one source of a radiant signal inducer 156; a signal detector 160; and an analyzer 161 in communication with the signal detector 160 configured to supply an output signal that is a function of an input signal 159 and one or more reference values. In the current embodiment, molecule 158 interacts with radiant signal inducer 157 and produces a signal 159. In the current embodiment, detector 160 detects the absorption of radiant signal inducer 157 by molecule 158 and signal 159 is normally lower when molecule 158 is present than if no molecule is present. One quantitative measure of absorption of a signal can be determined by calculating optical density.

Optical density is the absorbance of an optical element for a given wavelength λ per unit distance:

$${OD}_{λ} = \frac{{A}_{λ}}{l} = - \frac{1}{l} {log}_{10} T = \frac{1}{l} {log}_{10} ( \frac{{I}_{0}}{I} )$$

Where:

l=the distance that light travels through the sample (i.e., the sample thickness), measured in cm

A_{λ}=the absorbance at wavelength λ

T=the per-unit transmittance

I_b 0=the intensity of the incident light beam

I=the intensity of the transmitted light beam

Many suitable methods exist (including optical density) for quantitating absorption of a signal and analyzer 161 may be configured to supply an output signal that is a function of an input signal by making use of such methods of calculation. Another method that may be used involves measuring a reference signal that is detected by detector 160 with no molecule present and then subtracting the value of the signal 159 when the molecule is present. The difference will represent a signal value characteristic of the absorption of the molecule.

The example embodiment of FIG. 22 comprises a method for analyzing a property of at least one molecule. The method of the current example embodiment comprises: Isolating at least one molecule wherein said isolating depends substantially on the mass of the at least one molecule 158; subsequently Interacting the at least one molecule with a radiant signal inducer 157; detecting absorption of at least a part of the radiant signal inducer resulting from the interacting of the at least one molecule and the radiant signal inducer determining at least one property of the at least one molecule based on the detecting. The step of isolating is performed by the mass dependent molecule isolator 164. The step of interacting is performed when the molecule travels along its flight path 163 and intersects the path of the radiating signal inducer 157. The step of detecting absorption is performed by the signal detector 160. The step of determining at least one property is performed by the analyzer 161.

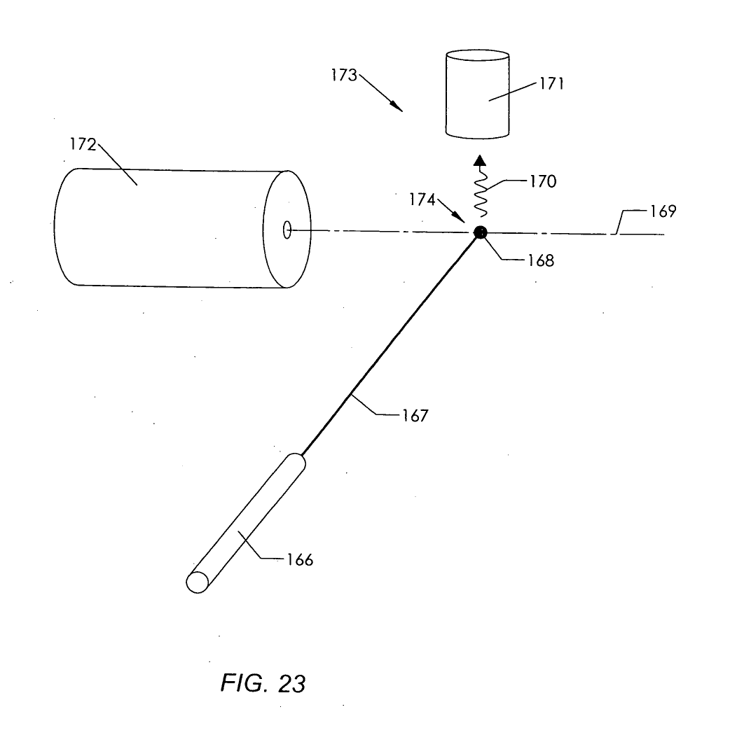

FIG. 23 shows an example embodiment molecule detector generally at 173 in communication with the mass dependent molecule isolator 172 the molecule detector comprises: a radiating signal inducer 167 which in the current embodiment is a particle beam; and a signal detector 171. The molecule 168 is isolated by the mass dependent molecule isolator 172 and travels along flight path 169 to the detection region generally at 174 where it interacts with the particle beam 167 and produces a signal 170 which is detected by detector 171. The signal 170 in the current embodiment comprises electromagnetic radiation. In alternate embodiments, the signals detected by detector 171 may comprise electromagnetic radiation or particle radiation and will depend upon the particle type of the radiating signal inducer and the molecule type being analyzed.

The example embodiment of FIG. 23 comprises a method for analyzing a property of at least one molecule. The method of the current example embodiment comprises: isolating at least one molecule wherein said isolating depends substantially on the mass of the at least one molecule; subsequently interacting the at least one molecule with a particle beam 167; detecting a signal 170 resulting from the interacting of the at least one molecule and the particle beam. The step of isolating is performed by the mass dependent molecule isolator 172. The step of interacting is performed when the molecule travels along its flight path 169 and intersects the path of the particle beam 167. The step of detecting is performed by the signal detector 171.

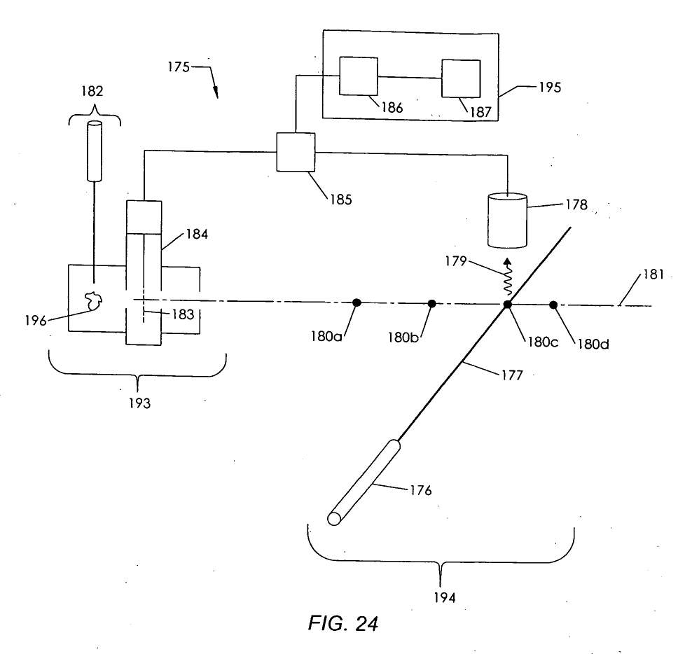

FIG. 24 shows an example embodiment apparatus generally at 175 for determining the sequence of subunits of at least one sample molecule comprising two or more subunits by analyzing two or more fragment groups having two or more fragment molecules 180a through 180d; each of the two or more fragment molecules having a known subunit in a known position; and each fragment group being prepared using the at least one sample molecule.

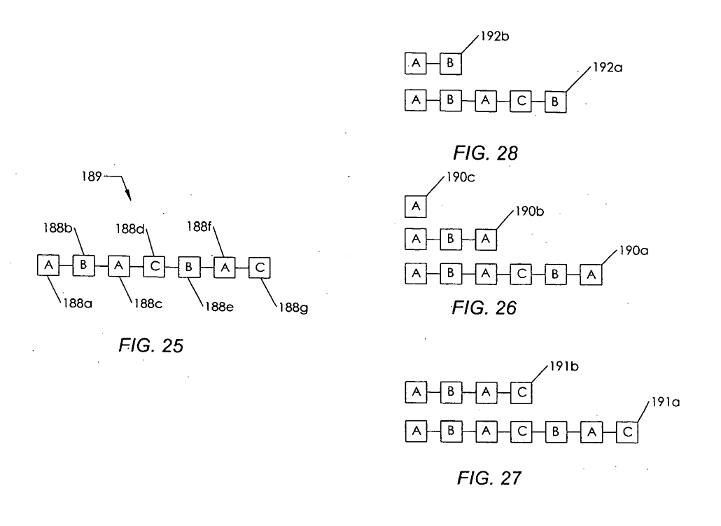

FIG. 25 shows an example molecule generally at 189 comprising two or more subunits (in this example 7) 188a through 188g, in this case the types of subunits that the molecule comprises are A, B and C. FIGS. 26, 27 and 28 each show different fragment groups. FIG. 26 shows a fragment group for the A subunit type and has three fragment molecules in its group. FIG. 27 shows a fragment group for the C subunit type and has two fragment molecules in its group. FIG. 28 shows a fragment group for the B subunit type and has two fragment molecules in its group. Each of the two or more fragment molecules have a known subunit in a known position. For example the fragment group shown in FIG. 26 has a known subunit, A at a known position—the right hand end position, these positions are 190a, 190b and 190c on each of the fragment molecules. Likewise, the fragment group shown in FIG. 27 has a known subunit, C at the right hand end position 191a and 191b on each of the fragment molecules. Similarly, the fragment group shown in FIG. 28 has a known subunit, C at the right hand end position 192a and 192b on each of the fragment molecules. Each of the fragment groups in FIGS. 26, 27 and 28 have been prepared using the molecule shown in FIG. 25. Many methods for preparing fragment groups for different molecule types exist and are well known. Some examples include enzymatic methods that use the sample molecule as a template such as the chain terminator sequencing (Sanger sequencing) reaction and the dye terminator sequencing reaction which may be used to prepare fragment groups for DNA. When DNA is sequenced in accordance with the present embodiment, the subunits are adenine, guanine, cytosine and thymine and the known position of the subunit in both dye terminator sequencing and Sanger sequencing is the end position of the fragment. Other methods for generating fragments for other molecules such as proteins RNA and polysaccharides make use of digestion or degradation.

Referring again to FIG. 24 the example embodiment shown generally at 175 comprises: A mass dependent molecule isolator 193; a molecule detector 194; a time measuring device 185 and an analyzer 195.

The mass dependent molecule isolator 193 is adapted to isolate at least one molecule wherein the isolation depends substantially on the mass of the at least one molecule and comprises: a molecular ionizer 182; and a molecular accelerator 183;

In the present example embodiment the molecular ionizer 182 is a matrix assisted laser desorption ionizer. The shape at 196 schematically represents a molecule sample to be analyzed. Other ionizers such as electro-spray ionizers may be substituted as will be evident to those skilled in the art. The molecular accelerator includes accelerating grid 196 and accelerating control unit 197 and accelerates the molecules after they are ionized by the molecular ionizer.

The molecule detector 194 is in communication with the mass dependent molecule isolator 193 and allows the isolated molecules to travel to the detector. The detector comprises at least one source of a radiant signal inducer 176 and a signal detector 178. The source of a radiant signal inducer in the present invention comprises a laser. The signal detector 178 comprises a photomultiplier tube.

The time measuring device 185 measures the time between acceleration of a fragment group by the molecular accelerator 183 and the reception of at least one signal 179 by the signal detector 178.

The analyzer 195 comprises a time measurement recorder 186 and a data processor 187. The time measurement recorder 186 is configured to record the time measurements made by the time measuring device 185 and to associate the measurements with a corresponding fragment group.

The data processor 187 configured to combine time measurements recorded for the two or more fragment groups an place the measurements in time order to thereby indicate at least a part of the sequence of subunits in the at least one sample molecule.

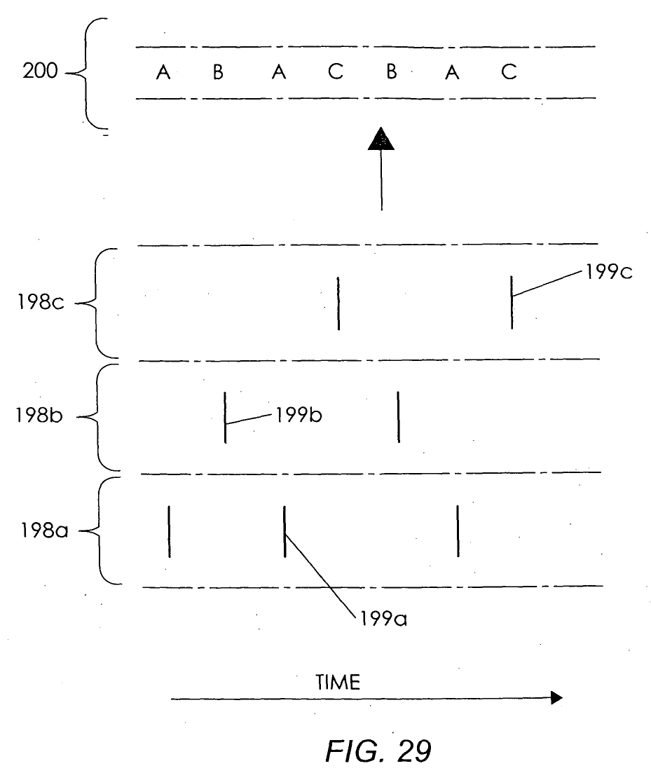

When a signal is detected by the molecule detector 194 the time measuring device communicates a time measurement to the time measurement recorder 186 where the data is stored and associated with the corresponding fragment group. In the present example embodiment different fragment groups are run separately and recorded by the time measurement recorder 186. FIG. 29 shows a schematic representation of the data recorded by the time measurement recorder. The lanes indicated by 198a, 198b and 198c schematically represent data recorded for each of the fragment groups. Lane 198a represents time recordings made for the fragment group representing the A subunits. Lane 198b represents time recordings made for the fragment group representing the B subunits. Lane 198c represents time recordings made for the fragment group representing the C subunits. The bars such as 199a an 199b indicate an individual time recording. The arrow labeled “Time” represents the time scale and bars farther right indicate time measurements made later in the run. The bar labeled 199a, for example, represents a time measurement for a fragment having an A subunit. The bar labeled 199b, for example, represents a time measurement for a fragment having an B subunit and was detected before bar 199a in time.

Once all fragment groups have been run, the data processor 187 combines the time measurements recorded for the fragment groups and places the measurements in time order. The process is illustrated schematically in FIG. 29. The data processor takes each of the time measurements from each lane and combines them into a single lane 200 in time order to thereby indicate at least a part of the sequence of subunits in the sample molecule. FIG. 29 represents this process schematically and the concept of lanes has been used to illustrate the data combination process in a visual fashion. For purposes of illustration the sample molecule depicted in FIG. 29 is shown in FIG. 25 and each of the fragment groups are shown in FIGS. 26, 27 and 28. The subunit designation has no significance other that to illustrate the principle. In example embodiments the subunits may be from, for example, DNA, RNA or proteins and may have more or less fragment groups.

The example embodiment of FIG. 24 comprises a method for determining at least one subunit of at least one sample molecule comprising two or more subunits. The method of the current example embodiment comprises: Isolating at least one fragment molecule 180c having a known subunit in a known position of the fragment molecule wherein the fragment molecule has been prepared using the at least one sample molecule, wherein said isolating depends substantially on the mass of the at least one fragment molecule; subsequently Interacting the at least one fragment molecule 180c with a radiant signal inducer 177; detecting a portion of the radiant signal inducer scattered 179 as a result of the interacting of the at least one fragment molecule and the radiant signal inducer; determining at least a part of the sequence of subunits based on the detecting. The step of isolating is performed by the mass dependent molecule isolator 193. The step of interacting is performed when the molecule travels along its flight path 181 and intersects the path of the radiating signal inducer 177. The step of detecting is performed by the signal detector 178. The step of determining at least a part of the sequence of subunits is performed by the analyzer 195.

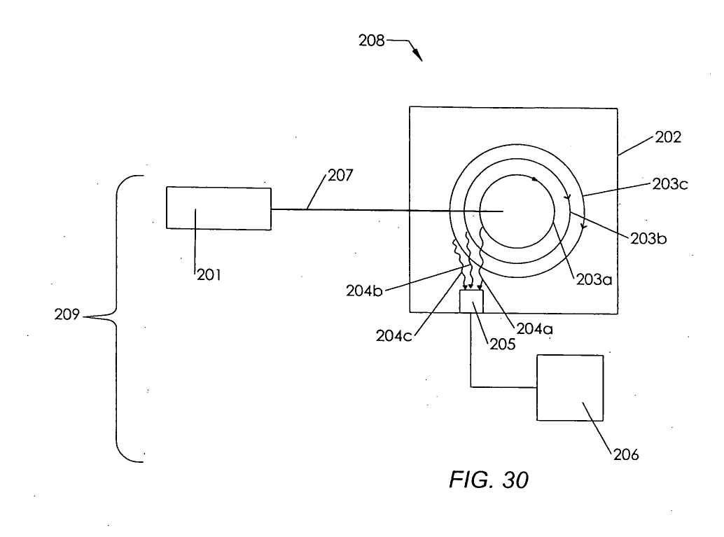

FIG. 30 shows an example embodiment generally at 208 comprising a mass dependent molecule isolator 202 adapted to isolate at least one molecule wherein the isolation depends substantially on the mass of the at least one molecule and a molecule detector 209 in communication with the isolator.

The mass dependent molecule isolator 202 in the current embodiment comprises a Fourier transform ion cyclotron resonance molecule isolator and further comprises a Fourier transform ion cyclotron resonance mass analyzer similar to that used in a Fourier transform ion cyclotron resonance mass spectrometer. In this type of molecule isolator the molecules are accelerated and allowed to circulate in a circular path as shown by 203a 203b and 203c. The circulation of the ions on this path depends upon the mass-to-charge ratio (m/z) of the ions based on the cyclotron frequency of the ions in the fixed magnetic field of the molecule isolator. Isolation of molecules in this detector occurs spatially as illustrated by the concentric paths 203a, 203b and 203c.

The detector 209 comprises a source of radiant signal inducer 201, a continuous wave laser in the present embodiment and a signal detector 205. The laser emits a radiant signal inducer 207, the laser beam that intersects the ion paths 203a, 203b and 203c. The interaction of the molecule ions with the radiant signal inducer 207 generates signals 204a, 204b and 204c that are detected by the signal detector 205. An analyzer unit 206 process the signals received by the detector 205 and performs a furrier transform on the data to deconvolute the data and associate it with its appropriate molecule.

FIG. 1A shows an example embodiment detector in cross-section view. This example embodiment detector is configured to detect a signal emitted from the molecule 13a who's flight path is perpendicular to the plane of the drawing. The detector comprises a source of a radiant signal inducer 12a; and photomultiplier tube 9a. The radiant signal inducer interacts with the molecule 13a and emits a signal 10a that is detected by photomultiplier tube 9a. The configuration shown in FIG. 1A is illustrative of the configuration comprised in the example embodiment of FIG. 1.

FIG. 1B shows an example embodiment detector in cross-section view. This example embodiment detector is configured to detect a signal absorbed by the molecule 13b who's flight path is perpendicular to the plane of the drawing. The detector comprises a source of a radiant signal inducer 12b; and photomultiplier tube 9b. The radiant signal inducer interacts with the molecule 13b and absorbs part of the radiant signal inducer to generate a signal 10b that is detected by photomultiplier tube 9b.

FIG. 1C shows an example embodiment detector in cross-section view. This example embodiment detector is configured to detect a signal scattered from the molecule 13c who's flight path is perpendicular to the plane of the drawing. The detector comprises a source of a radiant signal inducer 12c; and photomultiplier tube 9c. The radiant signal inducer interacts with the molecule 13c and scatters a signal 95a that is detected by photornultiplier tube 9c.

As noted, embodiments of the invention, are capable of very high throughput, require less maintenance and can be easily automated. This means that sequencing and molecular analysis can be performed at a significantly higher rate with fewer machines at substantially lower cost. This makes the invention well suited for large-scale sequencing and molecular analysis.

In another example embodiment, a method is provided for analyzing at least one molecule, the method including at least the following: isolating at least one molecule, wherein said isolating depends substantially on the mass of the at least one molecule; subsequently interacting the at least one molecule with a radiant signal inducer; and detecting a signal resulting from the interacting of the at least one molecule and the radiant signal inducer. The method, in one other example embodiment, further includes at least generating a report based on the detecting. In another example embodiment, the method further includes at least reporting at least a portion of the sequence in human-readable or machine-readable form. In another embodiment of the method, the isolating includes at least ionizing, accelerating, and allowing the at least one molecule to drift without additional acceleration. In yet another example embodiment of the method, the isolating includes at least the use of a mass spectrometer. In a further example embodiment of the method, the isolating includes at least the use of a time of flight mass spectrometer. In another example embodiment of the method the radiant signal inducer includes at least a source of electromagnetic. radiation. In yet another example embodiment of the method, the at least one molecule comprises an organic molecule. In a further example embodiment of the method, the at least one molecule includes at least a nucleic acid. In a further example embodiment of the method, the at least one molecule includes at least DNA. In a further example embodiment of the method, the at least one molecule includes at least RNA. In yet a further example embodiment of the method, the at least one molecule includes at least a protein.

Another example embodiment of the invention provides a method of determining at least one subunit of at least one sample molecule comprising two or more subunits, the method including at least: providing at least one sample molecule comprising two or more subunits; preparing a fragment molecule from said at least one sample molecule, said fragment molecule having a known subunit in a known position; isolating said at least one fragment molecule depending substantially on its mass; subsequently interacting the at least one fragment molecule with a radiant signal inducer, so as to induce said fragment to produce a radiant signal; detecting at least a portion of said radiant signal; determining at least a portion of a sequence of the subunits of said at least one fragment molecule based on said detecting; and generating a report based on said determining. In another embodiment of the method, the isolating includes at least ionizing, accelerating, and allowing the at least one sample molecule to drift without additional acceleration. In yet another example embodiment of the method, the isolating includes at least the use of a mass spectrometer. In a further example embodiment of the method, the isolating includes at least the use of a time of flight mass spectrometer. In another example embodiment of the method the radiant signal inducer includes at least a source of electromagnetic radiation. In yet another example embodiment of the method, the at least one sample molecule comprises an organic molecule. In a further example embodiment of the method, the at least one sample molecule includes at least a nucleic acid. In a further example embodiment of the method, the at least one sample molecule includes at least DNA. In a further example embodiment of the method, the at least one sample molecule includes at least RNA. In yet a further example embodiment of the method, the at least one sample molecule includes at least a protein.

A further example embodiment of the invention provides a method of generating a report comprising at least a portion of a sequence of subunits of at least one molecule, the method including at least: providing at least one sample molecule including at least two or more subunits; preparing a fragment molecule from said at least one sample molecule, said fragment molecule having a known subunit in a known position; isolating said at least one fragment molecule depending substantially on its mass; subsequently interacting the at least one fragment molecule with a radiant signal inducer, so as to induce said fragment to produce a radiant signal; detecting at least a portion of said radiant signal; determining at least a portion of a sequence of the subunits of said at least one fragment molecule based on said detecting; and reporting at least a portion of said sequence in human-readable or machine-readable form. In a further example embodiment of the method, the at least one sample molecule including at least two or more subunits includes at least a nucleic acid. In another embodiment of the method, the isolating includes at least ionizing, accelerating, and allowing the at least one sample molecule to drift without additional acceleration. In yet another example embodiment of the method, the isolating includes at least the use of a mass spectrometer. In a further example embodiment of the method, the isolating includes at least the use of a time of flight mass spectrometer. In another example embodiment of the method the radiant signal inducer includes at least a source of electromagnetic radiation. In yet another example embodiment of the method, the at least one sample molecule comprises an organic molecule. In a further example embodiment of the method, the at least one sample molecule includes at least a nucleic acid. In a further example embodiment of the method, the at least one sample molecule includes at least DNA. In a further example embodiment of the method, the at least one sample molecule includes at least RNA. In yet a further example embodiment of the method, the at least one sample molecule includes at least a protein.

Another example embodiment of the invention provides a method for determining at least one subunit of at least one sample molecule comprising two or more subunits, the method including at least: providing at least one sample molecule including at least two or more subunits; isolating at least one fragment molecule having a known subunit in a known position of the fragment molecule, wherein the fragment molecule has been prepared using the at least one sample molecule; wherein said isolating depends substantially on the mass of the at least one fragment molecule; subsequently interacting the at least one fragment molecule with a radiant signal inducer; detecting a portion of the radiant signal inducer scattered as a result of the interacting of the at least one fragment molecule and the radiant signal inducer; determining at least a part of the sequence of subunits based on the detecting; generating data based on said determining; analyzing the data; and producing a report based on the data.

A further example embodiment of the invention provides a method for analyzing (or, for example, in other embodiments, determining including: at least one subunit of at least one molecule comprising two or more subunits and/or the mass of, the atomic composition of, the concentration of same; at least nucleic acid sequencing which for example may include at least DNA sequencing and/or SNP analysis; and/or protein sequencing) a property of at least one molecule and/or at least one particle (or, for example, in other embodiments, at least one particle which may include at least nucleic acids and/or proteins present in a sample), the method including at least: isolating at least one molecule wherein said isolating depends substantially on the mass of the at least one molecule; subsequently interacting the at least one molecule with a radiant signal inducer; detecting resulting from the interacting of the at least one molecule (and/or particle) and the signal inducer; and determining at least one property of the at least one molecule based on the detecting. In another example embodiment of the method, the at least one molecule includes at least but is not limited to organic molecules and/or inorganic molecules. In certain embodiments, organic molecules include but are not limited to bio-molecules. In other embodiments, bio-molecules include but are not limited to small molecules such as for example, including at least but not limited to lipids, phospholipids, glycolipids, sterols, vitamins, hormones, neurotransmitters, carbohydrates, sugars and disaccharides. In other embodiments, bio-molecules include but are not limited to monomers including but not limited to amino acids, nucleotides, phosphates and monosaccharides. In other embodiments, bio-molecules include but are not limited to organic polymers including but not limited to nucleic acids (e.g., DNA, RNA, oligonucleotides, etc.), peptides (e.g., but are not limited to oligopeptides, polypeptides, proteins and antibodies, etc.), oligosaccharides and polysaccharides. In other embodiments, bio-molecules include but are not limited to macromolecules including but are not limited to prions. In another example embodiment of the method, the at least one molecule includes at least but is not limited to inorganic molecules including but not limited to inorganic monomers and inorganic polymers. In another example embodiment, the method includes at least but is not limited to isolating at least one atom. In another example embodiment, the method includes at least but is not limited to isolating at least one fragment molecule wherein the fragment has been prepared by using the at least one molecule as a template. In certain embodiments, the at least one fragment molecule has a known subunit in a known position on the fragment. In certain embodiments, the known subunit comprises a fluorescent tag that is characteristic of the subunit. In another example embodiment of the method, the at least one molecule, at least one atom, and/or the at least one fragment molecule comprises a tag. In certain embodiments, the tag includes at least a fluorescent tag. In another example embodiment, the method includes at least but is not limited to isolating, wherein the isolating depends at least partly on the mass of the at least one particle and/or at least one molecule or combination thereof. In another example embodiment, the method includes at least but is not limited to isolating, wherein the isolating includes at least ionizing, accelerating, and allowing to drift without additional acceleration. In another example embodiment, the method includes at least but is not limited to isolating, wherein the isolating includes use of at least a mass spectrometer. In some example embodiments, the mass spectrometer includes use of at least one of time-of-flight, magnetic-sector, and/or quadrupole mass spectrometry or combination thereof. In certain embodiments, ion-trap or Fourier transform may be used. In another example embodiment, the method includes at least but is not limited to interacting (and in one embodiment subsequently interacting) the at least one particle with a radiant signal inducer wherein the wherein the radiant signal inducer includes at least substantially a beam. Another example embodiment provides that the radiant signal inducer radiates in substantially non-parallel paths from at least one source. In another example embodiment, the method includes at least but is not limited to subsequently interacting the at least one particle with a radiant signal inducer which radiates at least electromagnetic radiation. In certain example embodiments, the electromagnetic radiation includes at least RF, microwave, infrared, visible, UV, x-ray and/or gamma ray radiation or combination thereof. In certain embodiments, the electromagnetic radiation includes a single signal inducing wavelength. In other embodiments, the electromagnetic radiation includes two or more signal inducing wavelengths. In another example embodiment, the method includes at least but is not limited to subsequently interacting the at least one particle with a radiant signal inducer which radiates at least one particle. In certain example embodiments, the at least one particle includes at least one or more of or a combination of a plurality of each of a: proton, neutron, electron, positron, alpha, and/or molecule or combination thereof. In another example embodiment, the method includes at least but is not limited to interacting (and in one embodiment subsequently interacting) the at least one particle with a radiant signal inducer wherein the signal inducer is emitted continuously from at least one source. In another example embodiment, the method includes at least but is not limited to interacting (and in one embodiment subsequently interacting) the at least one particle with a radiant signal inducer wherein the signal inducer is emitted from at least one source and comprises at least two on-pulses separated by an off-pulse. Another example embodiment provides controlling the off-pulse duration to be less than the time that the at least one molecule is in a position to interact with the signal inducer. In another example embodiment, the method includes at least but is not limited to interacting (and in one embodiment subsequently interacting) the at least one particle with a radiant signal inducer wherein the signal inducer is emitted from at least one source and comprises at least two off-pulses separated by an on-pulse. Another example embodiment provides that the interacting includes at least: determining when the at least one molecule will be in a position to interact with the signal inducer and timing the emission of at least one on-pulse of the signal inducer to allow interaction with the at least one molecule based on said determining. In another example embodiment, the method includes at least but is not limited to detecting a signal, including at least absorption of the radiant signal inducer by the at least one molecule. In another example embodiment, the method includes at least but is not limited to detecting a signal, including at least emission from the at least one molecule. In certain embodiments, the emission includes at least electromagnetic radiation. In certain example embodiments, the electromagnetic radiation includes at least RF, microwave, infrared, visible, UV, x-ray and/or gamma ray radiation or combination thereof. In certain embodiments, the emission includes at least one particle. In certain example embodiments, the at least one particle includes at least one or more of or a combination of a plurality of each of a: proton, neutron, electron, positron, alpha, and/or molecule or combination thereof. In certain embodiments, the emission includes at least electromagnetic radiation (e.g., including at least RF, microwave, infrared, visible, UV, x-ray and/or gamma ray radiation or combination thereof) and/or at least one particle (including at least one or more of or a combination of a plurality of each of a: proton, neutron, electron, positron, alpha, and/or molecule or combination thereof) having luminescence. In certain embodiments, the emission includes at least electromagnetic radiation (e.g., including at least RF, microwave, infrared, visible, UV, x-ray and/or gamma ray radiation or combination thereof) and/or at least one particle (including at least one or more of or a combination of a plurality of each of a: proton, neutron, electron, positron, alpha, and/or molecule or combination thereof) having luminescence. In another example embodiment, the luminescence includes at least but is not limited to one or more of or a combination thereof of Crystalloluminescence, Electroluminescence, Cathodoluminescence, Photoluminescence, Phosphorescence, Fluorescence, Radioluminescence, Thermoluminescence, and/or Triboluminescence. In another example embodiment, the method includes at least but is not limited to detecting a signal, including at least scattering of the radiant signal inducer. In another example embodiment, the method includes at least but is not limited to detecting a signal, including at least reflection of the radiant signal inducer. In another example embodiment, the method includes at least but is not limited to determining at least one property, wherein the determining includes at least determining at least a part of the sequence of subunits based on the detecting. In another example embodiment, the method includes at least but is not limited to determining at least one property, wherein the determining includes at least distinguishing at least one oligonucleotide molecule based on the detecting. In another example embodiment, the method includes at least but is not limited to determining at least one property, wherein the determining includes at least collecting the time correlated fluorescence emission signals. In certain embodiments, collecting the time correlated fluorescence emission signals includes at least analyzing by associating the time correlated fluorescent emission signals with the timing program to identify constituents. In another example embodiment, the method includes at least but is not limited to determining, wherein the determining includes at least determining the mass of the particle based on the time measured between said separation and said detecting. In another example embodiment, the method includes at least but is not limited to determining, wherein the determining includes at least determining a property of the at least one molecule by using a characteristic of the signal produced from the interaction.

A further example embodiment of the invention provides an apparatus for analyzing (or, for example, in other embodiments, determining including: at least one subunit of at least one molecule comprising two or more subunits and/or the mass of, the atomic composition of, the concentration of same; at least nucleic acid sequencing which for example may include at least DNA sequencing and/or SNP analysis; and/or protein sequencing) a property of at least one molecule and/or at least one particle (or, for example, in other embodiments, at least one particle which may include at least nucleic acids and/or proteins present in a sample), the apparatus including at least: a mass dependent particle isolator; a molecule detector in communication with the isolator; at least one source of a radiant signal inducer (and for example, interacting at least one molecule—[or one or more fluorescent species with one or more lasers configured to emit two or more excitation lines, each having a different wavelength with one or more lasers configured to emit two or more excitation lines, each having a different wavelength; and further in some embodiments controlling the interacting by means of a timing circuit coupled to the one or more lasers and configured to generate the two or more excitation lines sequentially according to a timing program]—with a source of electromagnetic radiation or at least one particle [including, for example, radiation or at least one particle as noted in the method example embodiment above]); a signal detector for detecting a signal (such as for example, including an emission which includes at least electromagnetic radiation and wherein in certain example embodiments, the electromagnetic radiation includes at least radio frequency (RF), microwave, infrared, visible, ultraviolet (UV) light, x-ray and/or gamma ray radiation or combination thereof. In certain embodiments, the emission includes at least one particle. In certain example embodiments, the at least one particle includes at least one or more of or a combination of a plurality of each of a: proton, neutron, electron, positron, alpha, and/or molecule or combination thereof. In certain embodiments, the emission includes at least electromagnetic radiation (e.g., including at least RF, microwave, infrared, visible, UV light, x-ray and/or gamma ray radiation, resonance or combination thereof to determine a sequence) and/or at least one particle (including at least one or more of or a combination of a plurality of each of a: proton, neutron, electron, positron, beta, alpha, and/or molecule or combination thereof) having luminescence. In another example embodiment, the luminescence includes at least but is not limited to one or more of or a combination thereof of Crystalloluminescence, El ectroluminescence, Cathodoluminescence, Photoluminescence, Phosphorescence, Fluorescence, Radioluminescence, Thermoluminescence, and/or Triboluminescence. In another example embodiment, the detector includes at least but is not limited to detecting a signal, including at least scattering of the radiant signal inducer. In another example embodiment, the detector includes at least but is not limited to detecting a signal, including at least reflection of the radiant signal inducer. In another example embodiment, the signal detector includes at comprising at least one wavelength dependent photon detector (which in certain embodiments is configured to collect the signals emitted by one or more mass groups).

In various embodiments as provided herein related molecules are prepared by a chain terminator sequencing reaction, may be fluorescent labeled, with two or more labels differentiable by wavelength (e.g. for SNP determination or for other purposes as noted herein). In example embodiments of various methods, apparatus and systems as provided herein detecting a signal (for example, based on scattered electromagnetic radiation, a fluorescent signal from the one or more fluorescent species, a signal emitted from the at least one molecule, the at least one photon, and otherwise as noted) resulting from the interacting of the at least one molecule and the radiant signal inducer (which may include for example the source of electromagnetic radiation, the one or more lasers, etc.) includes at least but is not limited to measuring the time between separation (e.g., wherein the signal inducer is emitted from at least one source and comprises at least two on-pulses separated by an off-pulse, or wherein the signal inducer is emitted from at least one source and comprises at least two off-pulses separated by an on-pulse) and said detecting and further the determining includes at least determining the mass of the particle based on the time measured between said separation and said detecting.

It should be noted that the design described does not limit the scope of the embodiments of invention; the number of various elements may change, or various components may be added or removed to the above-described concept.

The foregoing disclosure and description of embodiments of the invention is illustrative and explanatory of the above and variations thereof, and it will be appreciated by those skilled in the art, that various changes in the design, organization, order of operation, means of operation, equipment structures and location, methodology, the use of mechanical equivalents, such as different types of components than as illustrated whereby different steps may be utilized, as well as in the details of the illustrated construction or combinations of features of the various elements may be made without departing from the spirit of the embodiments of the invention. As well, the drawings are intended to describe various concepts of embodiments of the invention so that presently preferred embodiments of the invention will be plainly disclosed to one of skill in the art but are not intended to be manufacturing level drawings or renditions of final products and may include simplified conceptual views as desired for easier and quicker understanding or explanation of embodiments of the invention. As well, the relative size and arrangement of the components may be varied from that shown and the embodiments of the invention still operate well within the spirit of the embodiments of the invention as described hereinbefore and in the appended claims. Thus, various changes and alternatives may be used that are contained within the spirit of the embodiments of the invention. It is therefore desired that the invention not be limited to these embodiments, and it is intended that the appended claims cover all such modifications as fall within the true spirit and scope of the invention.

Accordingly, the foregoing specification is provided for illustrative purposes only, and is not intended to describe all possible aspects of the example embodiments of the invention. It also will be appreciated by those skilled in the art, that certain various changes in the ordering of steps, ranges, interferences, spacings, components, hardware, and/or attributes and parameters, as well as in the details of the illustrations or combinations of features of the methods and system discussed herein, may be made without departing from the spirit of the embodiments of the invention. Moreover, while various embodiments of the invention have been shown and described in detail, those of ordinary skill in the art will appreciate that changes to the description, and various other modifications, omissions and additions may also be made without departing from either the spirit or scope thereof.

### REFERENCES

The following references, to the extent that they provide exemplary procedural or other details supplementary to those set forth herein, are specifically incorporated herein by reference.

U.S. Pat. No. 5,171,534

U.S. Pat. No. 6,847,035B2

U.S. Pat. No. 6,995,841B2

U.S. Publication No. 2004/0057050

U.S. Pat. No. 6,806,464

U.S. Pat. No. 5,643,798

U.S. Pat. No. 5,691,141

U.S. Pat. No. 6,541,765B1

U.S. Pat. No. 6,281,493B1

U.S. Pat. No. 5,998,215

U.S. Pat. No. 5,681,752

Various articles or publications include the following:

Michael C. Fitzgerald and Lloyd M. Smith (1995). Mass Spectrometry of Nucleic Acids: The Promise of Matrix-Assisted Laser Desorption-Ionization (MALDI) Mass Spectrometry. Annu. Rev. Biophys. Struct. Vol. 24, 117-140.

Zhengdong Fei and Lloyd M. Smith ( ). Analysis of Single Nucleotide Polymorphisms in Human DNA by Single-Base Extension & MALDI-TOF Mass Spectrometry. Department of Chemistry, University of Wisconsin, Madison, Wis. 53706

John E. Coligan, Ben M. Dunn, Hiddle L. Ploegh, David W. Speicher, Paul T. Wingfield (1997). Chemical Analysis; Mass Spectrometry; and other chapter titles. Current Protocols in Protein Science. Vols. 1 and 2 (e.g., Vol. 2, sec. Chap. 11, and Vol. 2, pp. 11.0.1-11.9.29; 11.8.1-11.8.4). John Wiley & Sons, Inc.

C. G. Edmonds, L. M. Smith and R. D. Smith. (1990). Proceeding of the Relevance of Mass Spectrometry to DNA Sequence Determination: Research Needs for the Human Genome Program. Pacifi Northwest Laboratory, Seattle, Wash.

Gary R. Parr, Michael C. Fitagerald and Lloyd M. Smith. (1992). Matrix-assisted Laser Desorption/Ionization Mass Spectrometry of Synthetic Oligodeoxyribonucleotides. Rapid Communications in Mass Spectrometry, Vol. 6, 369-372.

Lloyd M.Smith. (1993). The Future of DNA Sequencing. Science, Vol. 262, 530-532.

Michael C. Fitzgerald, Lin Zhu and Lloyd M. Smith. (1993). The Analysis of Mock DNA Sequencing Reactions Using Matris-assisted Laser Desorption/Ionization Mass Spectrometry. Rapid Communications in Mass Spectrometry, Vol. 7, 895-897.

Christine M. Nelson, Lin Zhu, Wei Tang, Lloyd M. Smith, Kevin Crellin, Jamal Berry and Jesse L. Beauchamp. ( ). Fragmentation Mechanisms of Oligonucleotides in MALDI Mass Spectrometry.

Chad C. Nelson, Lesa M. Nelson and Kenneth Ward. ( ). Large-Scale Populationh Screening of Genetic Variants using ESI/MS Analysis of Multiplex PCR Products. Dept. of Human Genetics, University of Utah, Salt Lake City, Utah.

Huaiqin Wu and Hoda Aboleneen. ( ). Ladder Sequencing of Oligonucleotides with Both Termini Blocked Using Exonulease Digestion and Ionspray Mass Spectrometry. Abbott Laboratories, Diagnostics Division, Abbott Park, Ill. 60064.

Stephane Mouradian, Jeffrey W. Skogen, Frank D. Dorman, Fahimeh Zarrin, Stanley L. Kaufman and Lloyd M. Smith. (1997). DNA Analysis Using an Electrospray Scenning Mobility Particle Sizer. Analytical Chemistry, Vol. 69, 919-925.

Timothy, J. Griffin, Wei Tang and Lloyd M. Smith. (1997). Genetic Analysis by Peptide Nucleic Acid Affinity MALDI-TOF Mass Spectrometry. Nature Biotechnology, Vol. 15, 1368-1372.

Zhengdong Fei, Tetsuyoshi Ono and Lloyd M. Smith. (1998). MALDI-TOF Mass Spectrometic Typing of single Nucleotide Polymorphisms with Mass-tagged ddNTPs. Nculeic Acids Research, Vol. 26, 2827-2828.

Stephane Mouradian, David R. Rank and Lloyd M.Smith. (1996). Analyzing Sequencing Reactions from Bacteriophage M13 by Matrix-assisted Laser Desorption/Ionization Mass Spectrometry. Rapid Communications in Mass Spectrometry, Vol. 10, 1475-1478.

Xian Chen, Zhengdong Fei, Lloyd M. Smith, E. Morton Bradbury and Vahid Majidi. (1999) Stable-Isotope-Assisted MALDI-TOF Mass Spectrometry for Accurate Determination of Nucleotide Compositions of PCR Products. Anal. Chem. Vol. 71, 3118-3125.

Timothy J. Griffin and Lloyd M. Smith. (2000). Genetic Identification by Mass Spectrometric Analysis of Single-Nucleotide Polymorphisms: Ternary Encoding of Genotypes. Anal. Chem. Vol. 72, 3298-3302.

Zhengdon Fei and Lloyd M. Smith. (2000). Analysis of Single Nucleotide Polymorphisms by primer Extension and Matric-assisted Laser Desorption/ionization Time-of-Flight Mass Spectrometry. Rapid Communications in Mass Spectrometry, Vol. 14, 950-959.

Lloyd M. Smith. (1997). Diagnostic Gene Detection and Quantification Technologies. In: Diagnostic Gene Detectikon & Quantification Technologies for Infectious Agents & Human Genetic Diseases. Editor: Shelley A. Minden. Managing

Editor: Lynn M. Savage. International Business Communications, Inc. Southborough, Mass. 01772.

Lin Zhu, Gary R. Parr, Michael C. Fitzgerald, Christine M. Nelson and Lloyd M. Smith. (1995). Oligodeoxynucleotide Fragmenation in MALDI/TOF Mass Spectrometry Using 355-nm Radiation. J. American Chemical Society, Vol. 117, 6048-6056.

Wei Tang, Joern Krause, Lin Zhu and Lloyd M. Smith. (1997). Factor Influencing Oligonucleotide Stability in Matris-assisted Laser Desorption/Ionization (MALDI) Mass Spectroscopy. International J. of Mass Spectromery and Ion Processes. Vol. 169/170, 301-311.

Joern Krause, Mark Scalf and Lloyd M. Smith. (1999). High Resolution Characterization of DNA Fragment Ions Produced by Ultraviolet Matrix-Assisted Laser Desorption/Ionization Using Linear and Reflecting Time-Flight Mass Spectrometry. J. Am. Soc. Mass Spectrom. Vol. 10, 423-429.

Mark Scalf, Michael S. Westphill, Joern Krause, Stanley L. Kaufman and Lloyd M. Smith. (1999). Controlling Charge States of Large Ions. Science, Vol. 283, 194-197.

Timothy J. Griffin, Jeff G. Hall, James R. Prudent and Lloyd M. Smith. (1999). Direct Genetic Analysis by Matrix-assisted Laser Desorpition/Ionization Mass Spectrometry. Proc. Natl. Acad. Sci. USA, Vol. 96, 6301-6306.

Mark Scalf, Michael S. Westphill and Lloyd M. Smith. (2000). Charge Reduction Electroscopy Mass Spectrometry. Anal. Chem. Vol. 72, 52-60.

Daniel D. Ebeling, Michael S. Westphill, Mark Scalf and Lloyd M. Smith. ( ). Corona Discharge in Charge Reduction Electrospray Mass Spectrometry.

Lloyd M. Smith. (1993). Automated DNA Sequencing: A Look into the Future. Caner Detection and Prevention, Vol. 17, 283-288.

David Rank. (1996). Automated DNA Sequencers: The Next Generation. Optics & Photonics News, March, 30-33.

Michael S. Westphall, Robert L. Brumley Jr., Eric C. Buxton and Lloyd M. Smith. ( ). High-Speed Automated DNA Sequencing Utilizing from-the-side Laser Excitation. SPIE, Vol 2386, 45-54.

Joseph Sambrook, and David W. Russell. (2001) Molecular Cloning, A Laboratory Manual. 3^{rd} edition. Cold Spring Harbor Laboratory Press, Cold Spring Harbor, N.Y.

T. A. Brown. (1994). DNA Sequencing, The Basic. IRL Press at Oxford University Press, New York, N.Y.

J. Throck Watson. (1997). Introduction to Mass Spectrometry. 3^{rd} Edition. Lippincott-Raven Publishers, New York, N.Y.

Hobart H. Willard, Lynne L. Merritt, Jr. John A. Dean and Frank A. Settle, Jr. (1981). Instrumental Methods of Analysis. 6^{th} Edition. Wadsworth Publishing Company, Belmont, Calif.

Mark T. Roskey, Peter Juhasz, Igor P. Smirnov, Edward J. Takach, Stephen A. Martin and Lawrence A. Haff (1996). DNA sequencing by delayed extraction-matrix-assisted laser desorption/ionization time of flight mass spectrometry. Proc. Natl. Acad. Sci. USA. Vol. 93, pp. 4724-4729, May 1996. Biochemistry. PerSeptive Biosystems, 500 Old Connecticut Path, Framingham, Mass. 01701. Communicated by Klaus Biemann, Massachusetts Institute of Technology, Cambridge, Mass., Jan. 11, 1996 (received for review Nov. 10, 1995).
http://www.pubmedcentral.nih.gov/picrender.fcgi?artid=39346&blobtype=pdf

Finn Kirpekar*, Eckhard Nordhoff, Leif K. Larsen, Karsten Kristiansen, Peter Roepstorff, Franz Hillenkamp (1998). DNA sequence analysis by MALDI mass spectrometry. Department of Molecular Biology, Odense University, Campusvej 55, DK-5230 Odense M, Denmark and ¹Institute for Medical Physics and Biophysics, University of Münster, Robert-Koch-Strasse 31, D-48149 Münster, Germany. Received Mar. 10, 1998; Revised and Accepted Apr. 16, 1998.
http://nar.oxfordjournals.org/cgi/content/abstract/26/11/2554

N. I. Taranenko, S. L. Allman, V. V. Golovlev, N. V. Taranenkol, N. R. Isola and C. H. Chen* (1998). Sequencing DNA using mass spectrometry for ladder detection. 2488-2490 Nucleic Acids Research, 1998, Vol. 26, No. 10. Life Science Division, Oak Ridge National Laboratory, Oak Ridge, Tenn. 37831-6378, USA and 1 Yale University Medical Center, New Haven, Conn., USA. Received Dec. 3, 1997; Revised and Accepted Mar. 23, 1998.
http://www.pubmedcentral.nih.gov/nicrender.fcgi?artid=147544&blobtype=pdf

Eckhard Nordhoff,^{a} Christine Luebbert, Gabriela Thiele, Volker Heiser, and Hans Lehrach (2000). Rapid determination of short DNA sequences by the use of MALDI-MS. Nucleic Acids Res. 2000 Oct. 15 ; 28(20): e86. Max Planck Institute for Molecular Genetics, Ihnestrasse 73, 14195 Berlin, Germany. To whom correspondence should be addressed. Tel: +49 30 8413 1542; Fax: +49 30 8413 1139; Email: nordhoff@molgen.mpg.de. Received Aug. 21, 2000; Accepted Aug. 22, 2000.
http://www.pubmedcentral.nih.gov/articlerender.fcgi?artid=110802

Annette Kaetzke and Klaus Eschrich (2002). Simultaneous determination of different DNA sequences by mass spectrometric evaluation of Sanger sequencing reactions. Nucleic Acids Research, 2002, Vol. 30, No. 21 e117. Institute of Biochemistry, Medical Faculty, University of Leipzig, Liebigstrasse 16, D-04103 Leipzig, Germany. *To whom correspondence should be addressed. Tel: +49 341 9722105; Fax: +49 341 9739371; Email: eschrich@uni-leipzig.de
http://nar.oxfordjournals.org/cgi/content/abstract/30/21/e117

John R. Edwards, Yasuhiro Itagaki and Jingyue Ju* (2001). DNA sequencing using biotinylated dideoxynucleotides and mass spectrometry. Nucleic Acids Research, 2001, Vol. 29, No. 21 e104.
http://nar.oxfordjournals.org/cgi/content/full/29/21/e104

Kai Tang*, Dong-Jing Fu^{†}, Dominique Julien, Andreas Braun, Charles R.

Cantor, and Hubert Köster (1999). Biochemistry Chip-based genotyping by mass spectrometry (DNA chip/single nucleotide polymorphism) Vol. 96, Issue 18, 10016-10020, Aug. 31, 1999. Sequenom Inc., 11555 Sorrento Valley Road, San Diego, Calif. 92121.
Contributed by Charles R. Cantor, Jul. 12, 1999.
http://www.pnas.org/cgi/content/full/96/18/10016

John M. Butler and Christopher H. Becker (2001). Improved Analysis of DNA Short Tandem Repeats with Time-of-Flight Mass Spectrometry—Science and Technology Research Report. U.S. Department of Justice, Office of Justice Programs, National Institute of Justice. October 2001. NCJ 188292.
http://www.ncjrs.gov/ndffiles1/nij/188292.pdf

Beatrice Spottke, Julia Gross, Hans-Joachim Galla, and Franz Hillenkamp (2004). Reverse Sanger sequencing of RNA by MALDI-TOF mass spectrometry after solid phase purification. Nucleic Acids Res. 2004; 32(12): e97. Published online 2004 Jul. 7. doi: 10.1093/nar/gnh089. Institute for Medical Physics and Biophysics and ¹Institute for Biochemistry, University of Miinster, Münster, Germany and ²Department of Chemistry, Washington University, St Louis, Mo. 63130, USA. To whom correspondence should be addressed. Tel: +49 251 83 55103; Fax: +49 251 83 55121; Email: hillenk@uni-muenster.de. Received Apr. 27, 2004; Revised Jun. 4, 2004; Accepted Jun. 4, 2004.
http://www.pubmedcentral.nih.gov/articlerender.fcgi?artid=484192

Tae Seok Seo, Xiaopeng Bai, Dae Hyun Kim, Qinglin Meng, Shundi Shi, Hameer Ruparel, Zengmin Li, Nicholas J. Turro, and Jingyue Ju. (2005). Chemistry/Biophysics. Four-color DNA sequencing by synthesis on a chip using photocleavable fluorescent nucleotides. Published online before print Apr. 13, 2005, 10.1073/pnas.0501965102. PNAS|Apr. 26, 2005|vol. 102|no. 17|15926-5931. Columbia Genome Center, Columbia University College of Physicians and Surgeons, New York, N.Y. 10032; and Departments of Chemical Engineering, Chemistry, and Biomedical Engineering, Columbia University, New York, N.Y. 10027. Contributed by Nicholas J. Turro, Mar. 9, 2005.
http://www.pnas.org/cgi/content/full/102/17/5926

Hahner S, Olejnik J, Ludemann H C, Krzvmanska-Olejnik E, Hillenkamp F, Rothschild K J. (1999). Matrix-assisted laser desorption/ionization mass spectrometry of DNA using photocleavable biotin. Biomol Eng 1999 Dec. 31 ;16(1-4):127-33. AmberGen, Inc., Boston, Mass. 02215, USA.
http://www.ncbi.nlm.nih.gov/entrez/query.fcgi?cmd=Retrieve&db=PubMed&list_uid s=10796995&dopt=Abstract

Ineke Kleefsman¹, Michael Stowers¹, Jan. C. M. Marijnissen¹, Arjan L. van Wuijckhuijse² and Charles E. Kientz Aerosol Maldi—Mass Spectrometry for Bioaerosol Analysis. (1) Particle Technology Group, Faculty of Applied Physics, University of Technology—Delft, Julianalaan 136, Delft, Netherlands, (2) Prins Maurits Laboratory, TNO, Lange Kleiweg 137, Rijswijk, Netherlands
http://aiche.confex.com/aiche/s06/nreliminaryprogram/abstract_{—}44635.htm

Leo Kohyama, Hamamatsu Corporation. Photonic Detectors in Bioweapon Detection Systems.
http://www.usa.hamamatsu.com/assets/applications/Combined/Bioweapon-detection.pdf

IUPAC Compendium of Chemical Terminology 2nd Edition (1997). Tandem mass spectrometer. 1991, 63, 1546.

http://www.iupac.org/goldbook/T06250.pdf

The University of Bristol, School of Chemistry. MASS SPECTROMETRY RESOURCE Tandem Mass Spectrometry (MS/MS).
http://www.chm.bris.ac.uk/ms/theory/tandem-ms.html

Hybrid Mass Spectrometer Reduces Time Required To Identify Metabolites. Bioscience Technology.

http://www.biosciencetechnology.com/ShowPR_Print˜PUBCODE˜090˜ACC T˜9000000100˜ISSUE˜0310˜RELTYPE˜PR˜ORIGRELTYPE˜PAA˜PRODCODE ˜00000000˜PRODLETT˜B˜CALLFROM˜RELPGM.html

What is claimed is:

1. An apparatus for analyzing at least one molecule, the apparatus comprising:
a mass dependent molecule isolator adapted to isolate at least one molecule, wherein the isolation depends substantially on the mass of the at least one molecule; and
a molecule detector in communication with the isolator, the molecule detector comprising
at least one source of a radiant signal inducer, and
a signal detector.

2. An apparatus for analyzing at least one molecule, the apparatus comprising:
a mass dependent molecule isolator adapted to isolate at least one molecule, wherein the isolation depends substantially on the mass of the at least one molecule; and
a molecule detector in communication with the isolator, the molecule detector comprising
at least one source of a radiant signal inducer wherein the radiant signal inducer is emitted continuously from the at least one source, and
a signal detector comprising at least one wavelength dependent photon detector.

3. An apparatus for analyzing a property of at least one molecule, the apparatus comprising:
a mass dependent molecule isolator adapted to isolate at least one molecule, wherein the isolation depends substantially on the mass of the at least one molecule; and
a molecule detector in communication with the isolator, the molecule detector comprising
at least one source of a radiant signal inducer, wherein the radiant signal inducer is emitted from the at least one source and comprises at least two on-pulses separated by an off-pulse,
a duration control system to control the duration of the off-pulse to be less than the time that the at least one molecule is in a position to interact with the signal inducer, and
a photon discriminator comprising at least one wavelength dependent photon detector.

4. An apparatus for analyzing a property of at least one molecule, the apparatus comprising:
a mass dependent molecule isolator adapted to isolate at least one molecule wherein the isolation depends substantially on the mass of the at least one molecule; and
a molecule detector in communication with the isolator, the molecule detector comprising
at least one source of a radiant signal inducer wherein the radiant signal inducer is emitted from at least one source and comprises at least two off-pulses separated by an on-pulse,
a timing control system to time the emission of the at least one on-pulse of the signal inducer to allow interaction with the at lest one molecule, and
a photon discriminator comprising at least one wavelength dependent photon detector.

5. An apparatus for analyzing a property of at least one molecule, the apparatus comprising:
a mass dependent molecule isolator adapted to isolate at least one molecule, wherein the isolation depends substantially on the mass of the at least one molecule; and
a molecule detector in communication with the isolator, the molecule detector comprising
at least one source of a radiant signal inducer,
a signal detector, and
an analyzer in communication with the signal detector configured to supply an output signal that is a function of an input signal and one or more reference values.

6. An apparatus for analyzing a property of at least one molecule, the apparatus comprising:
a mass dependent molecule isolator adapted to isolate at least one molecule, wherein the isolation depends substantially on the mass of the at least one molecule; and
a molecule detector in communication with the isolator, the molecule detector comprising
a particle beam, and
a signal detector.

7. An apparatus for determining the sequence of subunits of at least one sample molecule comprising two or more subunits by analyzing two or more fragment groups having two or more fragment molecules; each of the two or more fragment molecules having a known subunit in a known position; and each fragment group being prepared using the at least one sample molecule, the apparatus comprising:
a mass dependent molecule isolator adapted to isolate at least one molecule, wherein the isolation depends substantially on the mass of the at least one molecule comprising
a molecular ionizer, and
a molecular accelerator;
a molecule detector in communication with the mass dependent molecule isolator, the detector comprising
at least one source of a radiant signal inducer, and
a signal detector;
a time measuring device for measuring the time between acceleration of a fragment group by the molecular accelerator and the reception of at least one signal from the signal detector; and
an analyzer comprising
a time measurement recorder configured to record the time measurements made by the time measuring device and to associate the measurements with its corresponding fragment group, and
a data processor configured to combine time measurements recorded for the two or more fragment groups an place the measurements in time order to thereby indicate at least a part of the sequence of subunits in the at least one sample molecule.

8. A method for analyzing at least one molecule comprising:
providing at least one molecule;
isolating the at least one molecule;
causing the at least one molecule to emit a signal; and
detecting the signal.

9. A method for analyzing at least one molecule, the method comprising:
isolating at least one molecule, wherein said isolating depends substantially on the mass of the at least one molecule;
subsequently interacting the at least one molecule with a radiant signal inducer; and
detecting a signal resulting from the interacting of the at least one molecule and the radiant signal inducer.

10. A method for analyzing at least one molecule, the method comprising:
isolating at least one molecule, wherein said isolating depends substantially on the mass of the at least one molecule;
subsequently interacting the at least one molecule with a radiant signal inducer,
wherein the radiant signal inducer is emitted continuously from at least one source;
causing the at least one molecule to emit at least one photon; and
detecting the at least one photon.

11. A method for analyzing a property of at least one molecule, the method comprising:
isolating at least one molecule, wherein said isolating depends substantially on the mass of the at least one molecule;
subsequently interacting the at least one molecule with a radiant signal inducer,
wherein the signal inducer is emitted from at least one source and comprises at least two on-pulses separated by an off-pulse,
wherein the interacting comprises: determining the amount of time that the at least one molecule will be in a position to interact with the signal inducer, and
controlling the off-pulse duration to be less than the time that the at least one molecule is in a position to interact with the signal inducer; and
detecting a signal emitted from the at least one molecule resulting from the interacting of the at least one molecule and the radiant signal inducer.

12. A method for analyzing a property of at least one molecule, the method comprising:
isolating at least one molecule wherein said isolating depends substantially on the mass of the at least one molecule;
subsequently interacting the at least one molecule with a radiant signal inducer,
wherein the signal inducer is emitted from at least one source and comprises at least two off-pulses separated by an on-pulse,
wherein the interacting further comprises: determining when the at least one molecule will be in a position to interact with the signal inducer, and
timing the emission of the at least one on-pulse of the signal inducer to allow interaction with the at lest one molecule based on said determining; and
detecting a signal emitted from the at least one molecule resulting from the interacting of the at least one molecule and the radiant signal inducer.

13. A method for analyzing a property of at least one molecule, the method comprising:
isolating at least one molecule wherein said isolating depends substantially on the mass of the at least one molecule;
subsequently interacting the at least one molecule with a radiant signal inducer;
detecting absorption of at least a part of the radiant signal inducer resulting from the interacting of the at least one molecule and the radiant signal inducer; and
determining at least one property of the at least one molecule based on the detecting.

14. A method for analyzing a property of at least one molecule, the method comprising:
isolating at least one molecule wherein said isolating depends substantially on the mass of the at least one molecule;
subsequently Interacting the at least one molecule with a particle beam; and
detecting a signal resulting from the interacting of the at least one molecule and the particle beam.

15. A method for determining at least one subunit of at least one sample molecule comprising two or more subunits, the method comprising:
isolating at least one fragment molecule having a known subunit in a known position of the fragment molecule,
wherein the fragment molecule has been prepared using the at least one sample molecule;
wherein said isolating depends substantially on the mass of the at least one fragment molecule;
subsequently interacting the at least one fragment molecule with a radiant signal inducer;
detecting a portion of the radiant signal inducer scattered as a result of the interacting of the at least one fragment molecule and the radiant signal inducer; and
determining at least a part of the sequence of subunits based on the detecting.

16. A system for determining a sequence of a plurality of components of a molecule, comprising:
an accelerator operable to accelerate a plurality of tagged molecules with an acceleration dependent on a respective mass of each of said plurality of tagged molecules, said plurality of tagged molecules comprising a tag and a mass, said tag being determinative of a particular component from among said plurality of components, said mass being representative of a position of said particular component in said sequence;
a chamber in which said tagged molecules are accelerated, said chamber comprising a length sufficiently long that said plurality of tagged molecules become spatially separated due to said acceleration based on a respective mass of each of said plurality of tagged molecules; and
a tag detector along said chamber for sequentially detecting a respective tag for said plurality of tagged molecules to determine said sequence of said plurality of components.

17. The system of claim 16 wherein said tag comprises at least one molecule and said detector comprises a radiating signal inducer such that a signal is detectable in response to interaction of said at least one molecule and said radiating signal inducer.

18. The system of claim 16 wherein said tag comprises said particular component.

19. The system of claim 16 wherein said tag comprises at least one dye or at least one fluorophore.

20. The system of claim 16, wherein said tag produces an emission detectable by said detector.

21. The system of claim 20, wherein said detector radiates a signal to induce said tag to produce said emission.

22. The system of claim 16, wherein said detector comprises at least one laser.

23. The system of claim 22, wherein said detector comprises at least one pulsed laser.

24. The system of claim 23, further comprising a timing circuit operable to fire said pulse laser as at least one of said plurality of tagged molecules is at a position in said chamber that said laser pulse will contact said at least one of said plurality of tagged molecules.

25. The system of claim 22, wherein said at least one laser is a continuous laser.

26. A method for determining a sequence of a plurality of components of a molecule, comprising:
producing a plurality of tagged molecules wherein each of said tagged molecules comprises a mass and a tag, said tag being determinative of a particular component from among said plurality of components, said mass being representative of a position of said particular component in said sequence;
accelerating said plurality of tagged molecules such that an acceleration for each of said tagged molecules is a function of said mass whereby a spatial position of said plurality of tagged molecules along a path of travel is a function of said mass; and
positioning a detector along said path of travel for sequentially detecting a respective tag for said plurality of tagged molecules to determine said sequence of said plurality of components.

27. The method of claim 26, wherein said tag comprises at least one molecule and said detector comprises a radiating signal inducer such that a signal is detectable in response to interaction of said at least one molecule and said radiating signal inducer.

28. The method of claim 26, wherein said tag comprises said particular component.

29. The method of claim 26, wherein said tag comprises at least one dye or at least one fluorophore.

30. The method of claim 26, wherein said tag produces an emission detectable by said detector.

31. The method of claim 30, wherein said detector radiates a signal to induce said tag to produce said emission.

32. The method of claim 26, wherein said detector comprises at least one laser.

33. The method of claim 32, wherein said detector comprises at least one pulsed laser.

34. The method of claim 33, wherein said at least one pulsed detector emits laser pulses with a timing such that said at least one pulsed laser emits a laser pulse when at least one of said plurality of tagged molecules is at a position along said path of travel that said laser pulse will contact said at least one of said plurality of tagged molecules.

35. The method of claim 32, wherein sat at least one laser is a continuous laser.
